(19) United States
(12) Patent Application Publication
(10) Pub. No.: US 2026/0301219 A1
(43) Pub. Date: Oct. 1, 2026

(54) METHOD FOR ASCERTAINING AT LEAST ONE DEGREE OF FREEDOM OF A CAMERA, COMPUTER PROGRAM, MACHINE-READABLE STORAGE MEDIUM, AND ELECTRONIC CONTROL UNIT OR AUTOMATION ARRANGEMENT

(71) Applicant: Robert Bosch GmbH, Stuttgart (DE)

(72) Inventor: Joachim Frangen, Heilbronn (DE)

(21) Appl. No.: 19/168,531

(22) PCT Filed: Mar. 15, 2024
(86) PCT No.: PCT/EP2024/057036

§ 371 Date: Sep. 24, 2025

(30) Foreign Application Priority Data
Apr. 5, 2023 (DE) 10 2023 203 162.0

(51) Int. Cl. G06T 7/73

(52) U.S. Cl. CPC G06T 7/74; G06T 2207/20016; G06T 2207/30244

(57) ABSTRACT

A method for ascertaining at least one degree of freedom of a camera relative to a code arrangement from a camera image of the camera. The code arrangement includes a dot raster with a plurality of base symbol. A coarse position of the base symbols is encoded in the code arrangement. The base symbols define a first and a second main direction, independent of the first, along the dot raster. The camera image defines a coordinate system. A coarse position of a base symbol in the coordinate system of the code arrangement in the plane of the code arrangement is ascertained from the camera image. A reference point is arranged in the camera image. First and second function arguments are determined based on the axis intersection point functions such that the reference point forms the first and the second axis intersection point.

### FIELD

The present invention relates to a method for ascertaining at least one degree of freedom of a camera relative to a code arrangement in the camera image of the camera. The present invention also relates to a computer program, a machine-readable storage medium with the computer program, and an electronic control unit or an automation arrangement with the electronic control unit.

### BACKGROUND INFORMATION

In modern manufacturing applications and other applications, it is necessary to detect a position of a moving body relative to the environment. For this purpose, there is a variety of sensor technologies, such as displacement transducers, encoded positions, which are read, etc. All existing sensor technologies have specific advantages for the particular application, which advantages may be based on accuracy, simplicity, inexpensive integration, robustness, or other properties.

German Patent Application No. DE 10 2016 216 221 A1 describes a method for positioning and/or for position determination of objects in a room and/or on a surface, the method using a two-dimensional code arrangement. The two-dimensional code arrangement comprises base symbols, wherein the base symbols are arranged on a surface and form a two-dimensional periodic raster on the surface. The position of a camera relative to the code arrangement can be ascertained on the basis of the code arrangement.

German Patent Application No. DE 10 2016 216 196 A1 describes a sensor system, wherein the sensor system uses the method for positioning and/or for position determination in German Patent Application No. DE 10 2016 216 221 A.

### SUMMARY

According to the present invention, a method for ascertaining at least one degree of freedom of a camera relative to a code arrangement from a camera image of the camera, an electronic control unit or an automation arrangement with the electronic control unit, a computer program, and a machine-readable storage medium are provided. Preferred or advantageous embodiments of the present invention arise from the disclosure herein.

The method according to the present invention is used to ascertain at least one degree of freedom of a camera relative to a code arrangement from a camera image of the camera.

The method is based on the method in German Patent Application No. DE 10 2016 216 221 A1 and/or German Patent Application No. DE 10 2016 216 196 A1, the disclosure of which is incorporated into the present disclosure by reference.

### Definition of Camera

In particular, the camera comprises an optical sensor unit (also referred to as an imaging sensor element, camera chip, or image sensor) for recording the camera image, and imaging optics. In particular, the camera is designed as a color camera or as a black-and-white camera. The optical sensor unit is designed to provide a single camera image of a portion of the code arrangement and/or a sequence of camera images, for example in the form of a video. The camera comprises an image sensor as the optical sensor unit. The camera may comprise an objective, wherein the objective is preferably designed as a wide-angle lens. In particular, the camera implements a vanishing point perspective and/or a central perspective. In particular, when viewed at an angle, parallel edges are not shown parallel in an image, but rather appear to converge at an imaginary point, the so-called vanishing point. In particular, the camera, in particular comprising the objective, implements an application-related desired perspective distortion.

### Definition of Optical Axis 5

The imaging optics is ideally a rotationally symmetrical optical system, wherein the axis of symmetry is the optical axis. It is characterized by a ray of light along the optical axis not experiencing any deflection when passing through the optics.

### Definition of Image Center 7

The point of intersection of the optical axis 5 with the optical sensor unit 12 is referred to as the image center 7. This image center may, but does not necessarily have to, coincide with the geometric center of the optical sensor unit 12.

### Definition of Camera Image

The camera image of the camera is in particular designed as a matrix, which comprises image points at the matrix points, for example 8-bit grayscale points or color points.

### Definition of Code Arrangement

The code arrangement is in particular imageable by the camera, wherein, on the basis of the camera image, the absolute position of a machine or a machine part is measurable in one to six degrees of freedom, for example. In particular, the code arrangement is designed to be detected by the camera by contactless reading, wherein multi-dimensional actual position determination can be performed as a result of the contactless detection by the camera. Preferably, the two-dimensional code arrangement can be used in a production system and/or test system, in which workpieces and/or testing equipment and/or work equipment need to be positioned.

### Definition of Base Symbol

The two-dimensional code arrangement comprises base symbols, wherein the base symbols are arranged on a surface and form a two-dimensional periodic raster, a dot raster, on the surface.

The base symbols are preferably geometric figures, such as circles, squares, triangles, or dashes. Particularly preferably, the base symbols are designed as circles. The base symbols are also referred to as dots. They preferably represent digits of a number system. In particular, the two-dimensional code arrangement comprises at least two different base symbols. In a possible embodiment of the present invention, the two-dimensional periodic raster comprises empty spaces as parcel symbols at raster positions and/or grid positions that are not populated with base symbols.

The base symbols are arranged on the surface, wherein the surface may be a curved or a non-curved surface. For example, the surface is the bottom of a production system and/or test system. The base symbols are arranged as a two-dimensional raster on the surface, wherein the centroids of the base symbols preferably form raster points in the dot raster.

### Definition of Dot Raster of the Code Arrangement

The raster points are also referred to below as raster positions and/or grid positions. In particular, the two-dimensional periodic dot raster forms a two-dimensional grid.

### Definition of Parcel

The surface is preferably divided into similar, regularly arranged parcels, wherein the parcels have, for example, a square, rectangular, triangular, or hexagonal basic shape. In particular, similar parcels are understood to be parcels of the same size and/or of the same shape. Preferably, each parcel comprises n base symbols. The parcels in particular comprise an integer number of base symbols and, specifically, an even number of base symbols. Preferably, the parcels comprise more than ten base symbols, in particular more than twenty base symbols and, specifically, more than forty base symbols. Furthermore, the number of base symbols in a parcel is preferably less than one hundred. The parcels formed by the base symbols may be visually indicated in the code arrangement, for example by a border, or may not visually be indicated and form only an imaginary and/or logical unit.

### Definition of Parcel Region

The parcels comprise at least a first and a second parcel region. An X parcel region comprises the first parcel region, and a Y parcel region comprises the second parcel region. In particular, each parcel region occupies a contiguous area or multiple distributed, non-contiguous subareas within the parcel.

Each parcel region comprises multiple base symbols. In particular, the X parcel region and the Y parcel region comprise the same number of base symbols. In particular, the at least two parcel regions are arranged in the parcel such that they have a p-fold rotational symmetry in relation to the center of the parcel as the center of rotation, wherein the p-fold rotational symmetry is, for example, a two-fold, three-fold, or four-fold rotational symmetry.

### Definition of Parcel Symbol

The parcels each comprise at least one parcel symbol, which represents a stationary reference point within each parcel. The parcel symbol makes it possible to read and/or decode the base symbols in a defined order. The parcel symbols are in particular regularly and/or periodically arranged in the two-dimensional periodic raster of the base symbols. The parcel symbols may be located on or next to the raster points. In particular, the parcel symbols are each arranged at the same position within a parcel, for example at the center of a parcel. The parcel symbols are, for example, different graphical elements than the base symbols, such as triangles, hexagons, or lines.

Alternatively and/or additionally, the parcel symbols are represented by omitting one or more base symbols in a parcel. In a possible embodiment, the parcel symbol forms the center of symmetry of the p-fold rotational symmetry of the parcel. In particular, the reading direction and/or decoding order, i.e., the order in which the base symbols within the X parcel region and/or within the Y parcel region must be read, is defined.

Preferably, the reading direction and/or decoding order corresponds to the specification of which base symbols are to be read and/or decoded one after the other.

### Definition of Encoding

In the X parcel region, an X coordinate value is encoded by the base symbols, and a Y coordinate value is encoded by the base symbols in the Y parcel region. In particular, the X coordinate value and the Y coordinate value are each the coordinate of a base symbol in the parcel, wherein the coordinate is specified in a Cartesian coordinate system of the area spanned by the base symbols. Alternatively and/or additionally, the X coordinate value and the Y coordinate value can also specify a position within the area as coordinates in a different coordinate system, such as an oblique coordinate system, in cylindrical coordinates or spherical coordinates.

### Definition of Preferred Embodiment of the Dot Raster

In a particularly preferred embodiment of the present invention, the two-dimensional periodic raster is a rectangular raster, wherein the parcels are also rectangular. In particular, the rectangular rasters and the rectangular parcels are square rasters and/or square parcels. Preferably, the distance between the base symbols along a length axis and a width axis of the rectangular raster is equal. For example, for a square raster with square parcels, the number of base symbols in the X and Y directions of the planar two-dimensional periodic raster is equal. In particular, the X parcel region and the Y parcel region each consist of two spatially separated rectangular subareas within a parcel, wherein the subareas have a longitudinal extent. The longitudinal extent of the subareas of the X parcel region is preferably perpendicular to the longitudinal extent of the subareas of the Y parcel region.

Preferably, the area occupied by the X parcel region can be transformed by a 90° rotation into the area occupied by the Y parcel region.

In a particularly preferred embodiment of the present invention, the periodic raster has a raster length and a raster width. The raster length extends in the X direction of a Cartesian coordinate system, the raster width in the Y direction. The coordinate system thus formed assigns an unambiguously determined position vector (X, Y) to each point of the encoding area.

In particular, a number of g consecutive base symbols forms an overall sequence. The overall sequence is entered into the X parcel regions, in particular into multiple parcels neighboring in the X direction. The base symbols are in particular entered into the X parcel regions according to their order in the overall sequence, preferably in the increasing X direction of the parcels, within each parcel in a predefined reading and/or decoding order. The number g is sufficiently large so that the X parcel regions of all parcels neighboring in the X direction can be completely filled. In particular, g is greater than fifty, in particular greater than a thousand and, specifically, greater than one million. The contents of the X parcel regions of parcels neighboring in the Y direction are identical. It is particularly preferred that a portion of t consecutive base symbols in the overall sequence forms a subsequence. In particular, each portion of t consecutive base symbols of the overall sequence forms a subsequence, wherein the consecutive base symbols follow one another in the decoding and/or reading order. In particular, the overall sequence is designed such that each subsequence of t consecutive base symbols read forward is included in the overall sequence only once, and each subsequence read backward is not included in the overall sequence read forward. Preferably, a subsequence comprises at least five consecutive base symbols, in particular at least twenty consecutive base symbols and, specifically, at least thirty base symbols. Furthermore, the subsequence preferably comprises less than fifty base symbols and, specifically, less than thirty base symbols. In particular, t<g.

In a particularly preferred embodiment of the present invention, the base symbols are designed to encode digits for a number base b. The number base b is preferably the base of a positional number system. Preferably, the number base is b=2, the base of a binary system, wherein the digits of the binary system comprise 0 and 1. Furthermore, it is possible that the number base is b=10 and forms the base of a decimal system, wherein the decimal system comprises the digits 0, 1, 2, 3, 4, 5, 6, 7, 8, and 9. Alternatively, the number base is b=16, the base of a hexadecimal system, wherein the hexadecimal system comprises the digits 0, 1, 2, 3, 4, 5, 6, 7, 8, 9, A, B, C, D, E, and F. In particular, the number base b can be selected as desired, wherein the digits of the number base comprise the elements 0, 1, . . . , b−1. Alternatively and/or additionally, the number base b is the base of an additive number system, for example the Roman number system.

In a particularly preferred embodiment of the present invention, the number base b=2 is selected. In particular, the selected number base b=2 forms a binary system. The binary system and/or the number system with the number base b=2 comprises two digits, in particular the digit 0 and the digit 1.

Preferably, two different base symbols encode the digits 0 and 1 of the binary system. The two different base symbols are formed by two circles, a first circle with a radius R1 and a second circle with a radius R2. In particular, the radius R1 is selected to be smaller than the radius R2. In particular, the ratio of radius R2 to radius R1 is greater than the square root of 2. For example, the radius R2 is selected to be less than half the raster spacing of the code raster so that two circles with R2 that are neighboring in the periodic raster are not tangent to each other. This embodiment is based on the consideration that a particularly high density of information is achieved on the one hand, while safe readability with standard image processing methods, such as segmentation by means of blob analysis, is achieved on the other hand.

In a possible embodiment of the present invention, the overall sequence is designed such that a digit sum of a subsequence is less than half the maximum possible digit sum of a subsequence.

In particular, for any subsequence selected from the overall sequence, the digit sum is less than half the maximum possible digit sum of a subsequence. For example, the digit sum of each subsequence of length t for a number system with base b is less than t·(b−1)/2.

In a particularly preferred embodiment of the present invention, the two-dimensional code arrangement comprises an inverted overall sequence. The inverted overall sequence preferably represents an inversion of the overall sequence. Preferably, the inverted overall sequence is entered into the Y parcel regions of multiple parcels neighboring in the Y direction. The base symbols are in particular entered into the Y parcel regions according to their order in the inverted overall sequence, preferably in the increasing Y direction of the parcels, within each parcel in the predefined reading and/or decoding order. The number g is sufficiently large so that the Y parcel regions of all parcels neighboring in the Y direction can be completely filled. In particular, the contents of the Y parcel regions of parcels neighboring in the X direction are identical.

In a possible embodiment of the present invention, the base symbol at the k-th position of the inverted overall sequence is the encoded digit m(k), wherein the digit m(k) with the digit n(k) encoded by the base symbol at the k-th position in the overall sequence satisfies the relation: m(k)=b−n(k)−1.

For example, the inverted overall sequence and the overall sequence for selecting a binary system with the base b=2 forms the relation: m(k)=1−n(k).

### Definition of Point of Incidence

Particularly preferably, the portion comprises a point of incidence. For example, the point of incidence is the point of intersection of the optical axis of the camera with the plane in which the code arrangement is located. Preferably, the method is designed, on the basis of the image captured by the sensor unit, to determine the position of the camera in relation to the work area, for example the X coordinate (rx) and the Y coordinate (ry) of the point of incidence in a coordinate system that is spanned by the work area and/or the base symbols and/or the code arrangement.

First, the method determines only the coarse position in the form of the encoded X coordinate and the encoded Y coordinate as two degrees of freedom. The coarse position already provides a reliable and usable position for the coarse positioning of the camera.

By determining the X coordinate and the Y coordinate in the code arrangement as a coarse position, the relative position of the camera in relation to the code arrangement can be deduced. If, for example, the coarse position in the immediate vicinity of the point of incidence is determined, knowledge of the course of the optical axis of the camera can be used to deduce the position of the camera. A quasi-exact position of the camera is obtained in that the point of incidence is equal to the encoded position and the angles of the optical axis relative to the code arrangement is known. The simplest case is that the optical axis is aligned perpendicular to the code arrangement.

### Definition of Degrees of Freedom

In a particularly preferred embodiment of the present invention, the method is designed to determine the position and/or the pose of the work module with respect to the work area in up to six degrees of freedom. The degrees of freedom are in particular:
rx: position coordinate in the coordinate system of the code arrangement (as coarse position and/or fine position).
ry: position coordinate in the coordinate system of the code arrangement (as coarse position and/or fine position).

In particular, rx and ry relate to the point of incidence, in particular the point of penetration by the optical axis through the code arrangement.
rz: distance between the reference point and the camera along the optical axis.
phiz: Z angle of rotation of the camera about the optical axis.
phix: first pitch angle of the optical axis to the code arrangement, in particular in relation to the first main direction.
phiy: second pitch angle of the optical axis to the code arrangement, in particular in relation to the second main direction.

### Definition of X, Y Coordinate (Rx, Ry)

For example, the six degrees of freedom of the position and/or pose of the camera relative to the work area include the coordinates X and Y with respect to the Cartesian coordinate system spanned by the base symbols, in particular in a coordinate system (X_{C}, Y_{C}) of the code arrangement in the plane of the code arrangement.

### Definition of Distance Between the Point of Incidence and the Optical Center of the Camera (Rz)

Furthermore, the 6 degrees of freedom include the distance Z or Iz between the camera and the point of incidence along the optical axis, wherein the distance is, for example, the distance between the point of incidence and, for example, the optical center of the camera objective.

### Definition of Angles of Rotation

Furthermore, the three independent angles of rotation of the camera in a camera coordinate system are determined. Two of the angles of rotation are in particular defined as angles between the optical axis and the code arrangement (phix, phiy). The third angle of rotation (phiz) denotes the rotation of the camera about the optical axis.

### Definition of Coordinate System of the Code Arrangement

The coordinate system (X_{C}, Y_{C}) of the code arrangement is located in the plane of the code arrangement.

### Definition of Coordinate System of the Image Sensor of the Camera and/or in the Camera Image

The coordinate system (X_{I}, Y_{I}) of the image sensor is located in the plane of the image sensor or in the camera image.

### Definition of Camera Coordinate System

The coordinate system (X, Y, Z) of the camera has its origin in the optical center of the camera objective, wherein the negative Z direction is coincident with the optical axis of the camera.

### Generalization:

While the coordinate systems are exemplified with regard to the origin and the alignment, equivalent coordinate systems may also be used.

### Definition of Method

In the method of the present invention in some variants, the X coordinate value and the Y coordinate value are decoded and/or determined on the basis of the camera image captured by the camera. In a possible development of the method, the orientation of the portion with respect to three coordinate axes is determined on the basis of the portion of the code arrangement captured in the image. In particular, the orientation of the portion, captured in the image, with respect to the X axis and the Y axis of the Cartesian coordinate system spanned by the base symbols is determined. Alternatively and/or additionally, the coordinates of the position of the point of incidence in the code arrangement are determined by decoding the portion of the code arrangement included in the image. In a particularly preferred embodiment of the present invention, the method determines the pose of the work module relative to the work area in up to six degrees of freedom. In particular, the pose of the camera in the work area is determined in three Cartesian coordinates X, Y, Z, where X and Y are the coordinates of the coordinate system spanned by the base symbols and Z is the distance between the work module and the work area. Furthermore, the method determines the three Euler angles of the camera, for example.

Alternatively and/or additionally, the two-dimensional code arrangement is used in areas outside automation technology, for example for monitoring movement sequences in nature and environment, biology and medicine, architecture, entertainment electronics, and/or sensor technology.

Depending on the variant, the general advantages of the present invention are:

An object of the present invention is to provide a high-performance, reliable and inexpensive method for locating and identifying one or more objects in a work space in up to six degrees of freedom (6D localization=simultaneous position detection in 6 degrees of freedom of movement).

The method of the present invention processes image data provided by an imaging measurement system, for example a camera.

For image capture and for ascertaining the position with the method according to the present invention, a smartphone can, for example, also be used, wherein the method is implemented as an algorithm in an application executed by the embedded computer of the smartphone or in the cloud.

In order to determine the position of an object in up to six degrees of freedom, the camera detects a two-dimensional code arrangement associated with the object to be located.

Depending on the variant, the method according to the present invention has the following properties:
Up to complete 6D position information: Translation (X, Y, Z) and rotation (φ_X, φ_Y, φ_Z)
Absolute position information (not incremental), i.e., a reference run as with incremental sensors is omitted
Very large measurement range:
in X, Y, “virtually infinite,” limited only by the code arrangement. Examples: unambiguously encodable area when using the code described in [B] and the dot raster 2.5 mm:
for parcel size 5×5 dots: 2 m×2 m
for parcel size 7×7 dots: 8 km×8 km
for parcel size 9×9 dots: 550,000 km×550,000 km in Z: only dimension with limitation. Adaptable to the application via camera resolution, objective, and raster spacing of the code arrangement.
in φ_X, φ_Y: currently +/−60° in φ_Z infinite (0°-360°)
High measurement rate, for example 100 Hz-10,000 Hz
Short latency (time from image capture to output of 6D position measurement value), e.g., 10 ms-100 μs.
High measurement accuracy in all six degrees of freedom: currently 1 μm and 0.01° repeatability (at 3 sigma), with a code raster spacing of 2.5 mm
Maximum reading reliability, even in the case of local interference in the image or fluctuations in image brightness
Inexpensive to implement, both the sensor system and the code arrangement
Additional data can be read, concurrently with the localization. For example, an ID code for identifying the object, which code is integrated in the code arrangement, can be read.
Scalable with regard to accuracy, measurement range in Z, redundancy, and measurement rate by changing objective, image sensor resolution, raster spacing of the code arrangement, reading field size, computing power, etc.
Easy integration into existing systems, for example as a smartphone app.

This makes it easy to implement a variety of automation-related applications that could previously not be implemented or not be implemented economically, for example
Precise localization of axes or carriages in an axis system or robotic system in order to implement real-time pose control in up to six dimensions.
Setup of absolute positioning systems and robots that do not require a reference run
Simplification of positioning systems since multiple one-dimensionally measuring sensors can be replaced by one multi-dimensionally measuring sensor.
Visual servoing, e.g., for guiding a robotic gripper to a moving target.
Monitoring and tracking of multiple objects in space by cyclic position measurement
Recording and analysis of movement sequences
Vibration analysis of machines in 6 dimensions.
Determination of the relative pose of two objects. A camera, for example in a hand-held device, detects two objects, each equipped with a dot code, in an image. The proposed method allows locating both objects in relation to the common camera coordinate system. The relative pose of the two objects to one another can be ascertained by vector subtraction. The position of the camera is eliminated computationally, i.e., the method is in largely independent of the camera position.
Determination of the relative pose of more than two objects, each equipped with cameras and/or code arrangements.
Setup of a localization network, e.g., in a production hall, in order to locate multiple stationary or moving objects relative to one another or relative to a hall coordinate system.

For example, multiple autonomous vehicles each equipped with a camera localize themselves by detecting a code arrangement attached to the hall ceiling.

According to an example embodiment of the present invention, the code arrangement has a dot raster with a plurality of base symbols, wherein the centers of the base symbols are preferably located at the raster points, and wherein a coarse position of the base symbols is encoded in the code arrangement.

The base symbols define a first and a second main direction, independent of the first, along the dot raster. Depending on the viewing angle, the two independent main directions in the camera image are aligned perpendicular or oblique to each other.

In particular, a base symbol matrix is ascertained from the camera image, wherein the position of the base symbols in the camera image is entered in the base symbol matrix. A position in the base symbol matrix thus refers to the position of the base symbol in the dot raster, in particular in a coordinate system of the image sensor and/or in a coordinate system of the camera image.

The dot raster in the camera image is in particular perspectively distorted so that the rows and columns of the dot raster are each rectilinear, but the rows and columns in the perspective distortion are arranged not perpendicular, but oblique to one another. In addition, optical distortion can also occur, which can optionally be compensated by rectification.

According to an example embodiment of the present invention, on the basis of the base symbols or a selected subset thereof, the coarse position of at least one of the base symbols in the code arrangement is determined as two degrees of freedom of the camera relative to the code arrangement.

A reference point is arranged in the camera image. The reference point may be positioned as desired. In preferred embodiments of the present invention as described below, the reference point is designed as a point of intersection of the optical axis with the image sensor and/or with the camera image. The reference point is thus specified by the camera in the coordinate system of the camera and/or in the camera image.

A first axis intersection point function in the coordinate system of the camera image is formed by a first straight line.

In the coordinate system of the code arrangement, the first straight line is aligned parallel to the first main direction of the dot raster. The axis intersection point function has a first function argument, wherein changing the first function argument shifts the first straight line parallel in the second main direction in the coordinate system of the code arrangement. The first axis intersection point function defines, as a function of the first function argument, a first axis intersection point along a first axis of the coordinate system of the camera image, wherein the first axis passes through the reference point.

Shifting the first straight line by changing the first function argument in the coordinate system of the code arrangement thus shifts, in a perspectively distorted manner, the first straight line in the coordinate system of the camera and/or of the camera image such that the axis intersection point moves along the first axis.

Furthermore, according to an example embodiment of the present invention, a second axis intersection point function in the coordinate system of the camera image is formed by a second straight line. In the coordinate system of the code arrangement, the second straight line is aligned parallel to the second main direction of the dot raster. The axis intersection point function has a second function argument, wherein changing the second function argument shifts the second straight line parallel in the second main direction in the coordinate system of the code arrangement. The second axis intersection point function defines, as a function of the second function argument, a second axis intersection point along a second axis of the coordinate system of the camera image, wherein the second axis passes through the reference point. Shifting the second straight line by changing the second function argument in the coordinate system of the code arrangement thus shifts, in a perspectively distorted manner, the second straight line in the coordinate system of the camera and/or of the camera image such that the axis intersection point moves along the second axis.

On the basis of the axis intersection point functions, the first and the second function argument are determined such that the reference point forms the first and the second axis intersection point. Illustratively speaking, the first function argument is varied until the first straight line in the coordinate system of the camera and/or of the camera image passes through the reference point and/or the first axis intersection point is located on the reference point. In the same way, the second function argument is varied until the second straight line in the coordinate system of the camera and/or of the camera image passes through the reference point and/or the second axis intersection point is located on the reference point.

Subsequently, on the basis of the first and the second function argument and the coarse position, the fine position of the reference point in the coordinate system of the code arrangement in the plane of the code arrangement is determined.

Conceptually, the coarse position of the base symbol in the coordinate system of the code arrangement is determined first, and a shift of the base symbol to the reference point is subsequently determined on the basis of the function arguments.

The method of the present invention has the advantage that the coarse position of the base symbol can be determined by decoding the code arrangement. Subsequently, the shift to the reference point is calculated on the basis of the axis intersection point functions, wherein the calculation can be performed with few calculated values and thus computationally efficiently by using the axis intersection point functions. This has the advantage that the method can also be performed in real-time applications with digital data processing device, in particular microcontrollers, with low computing power.

In a preferred embodiment of the present invention, the first function argument is designed as a count value of the rows and/or the second function argument is designed as a count value of the columns in the dot raster. Illustratively speaking, the position of the base symbol, whose coarse position is known, is shifted to the reference point by whole steps or partial steps of the raster spacing of the dot raster.

As discussed above, the reference point is particularly preferably designed as a point of intersection of the optical axis of the camera with the image sensor. The reference point is thus defined as a constructive position in the coordinate system of the camera and/or of the camera image. However, it is not absolutely necessary that the reference point and/or the point of intersection is arranged precisely centrally in the camera image and/or on the image sensor of the camera. Rather, the position of the reference point can be defined via a calibration.

In a possible embodiment of the present invention, the axis intersection point function is designed as a linear function for describing the straight line. In this case, the axis intersection point function comprises a full mathematical description of the straight line as a function of the particular function arguments.

Alternatively, according to an example embodiment of the present invention, a linear function is used, which is formed by a combination of a line angle function of the line angle as the angle of intersection of the straight line with one of the axes of the coordinate system of the camera image as a function of the function argument and the axis intersection point function.

The straight line is thus completely described by an axis intersection point and a line angle. This division has the advantage that, for determining the fine position, only the axis intersection point function has to be determined and/or evaluated, namely, without information on the line angle. This embodiment further increases the efficiency of the method.

On the basis of the function arguments and a known raster spacing of the dot raster, the fine position can then be determined. Illustratively speaking, the fine position is determined such that, for example, starting from the position of the base symbol with the known coarse position, a move by a fraction of a raster spacing in the first main direction and a fraction of the raster spacing in the second main direction is necessary to reach the reference point in the coordinate system of the code arrangement. This representation is particularly computationally efficient.

According to an example embodiment of the present invention, from the data of the base symbol matrix, a first linear function is preferably determined as one of the linear functions in a coordinate system of the camera image for a first straight line with the first function argument. Independently of the first function argument, the first straight line is always parallel to the first main direction of the dot raster when the first straight line is mentally transferred to the coordinate system of the code arrangement. Changing the first function argument shifts the first straight line parallel in the second main direction in the coordinate system of the code arrangement.

Changing the first function argument can thus, for example, place the straight line on a row of the dot raster, both in the coordinate system of the code arrangement and in the coordinate system of the camera image.

In particular, this can be implemented as follows:

### Initial Situation:

a) The centers of the base symbols form a two-dimensional dot raster with regularly arranged rectilinear rows and columns in the code plane.
b) The camera projects the code plane in a perspectively distorted manner onto the image sensor. In the camera image, the rows generally appear as fanned lines that have a common vanishing point. The same applies to the columns.
c) As a result of the distortion by the objective, the rows and columns in the camera image appear as curved lines.

Method steps in the camera coordinate system according to an example embodiment of the present invention:
a) The distortion by the objective is mathematically eliminated through rectification, the curved lines are converted into straight lines.
b) By linear interpolation, straight lines are adjusted to the rows and numbered with an integer index as a function argument according to their order. They form a first line bundle. An analogous procedure is applied to the columns, they form a second line bundle.
c) Each straight line is described by a line angle and an intercept value. The line angles of a bundle form a sequence of numbers, which is approximated by quadratic interpolation.

The integer line index is used as a function argument. The polynomial has three interpolation parameters. An analogous procedure is applied to the intercept value, resulting in three further interpolation parameters. Each line bundle is thus described fully and compactly by six interpolation parameters.
d) Straight lines that are located between two rows or columns can also be calculated by inserting rational function values into the interpolation function.

Alternatively or additionally, according to an example embodiment of the present invention, on the basis of the base symbol matrix, a second linear function as a further one of the linear functions in a coordinate system of the camera image is determined for a second straight line with the second function argument. Independently of the second function argument, the second straight line is always parallel to the second main direction of the dot raster when the second straight line is transferred to the coordinate system of the code arrangement.

Changing the second function argument shifts the second straight line parallel in the first main direction in the coordinate system of the code arrangement. Changing the second function argument can thus, for example, place the straight line on a row of the dot raster, both in the coordinate system of the code arrangement and in the coordinate system of the camera image.

It should be noted that the terms “row” and “column” are in particular used only for designation and do not mean a specific alignment of the dot raster.

The at least one degree of freedom of the camera can be ascertained on the basis of at least one of the linear functions. Optionally, the at least one degree of freedom of the camera can be ascertained on the basis of both linear functions.

It is a further consideration of the present invention that the amount of data on the way from the camera image to the at least one degree of freedom is to be reduced in order to make it possible to calculate the at least one degree of freedom more quickly and/or more efficiently. For example, while the camera image with an image size of 200×200 pixels still has 40,000 values, the base symbol matrix is already reduced to the position and accordingly has only 225 values for the positions in a portion of the camera image, e.g., with an edge length of the dot raster of 15 base symbols. By deriving the at least one linear function, the amount of data is reduced to the parameters of the linear function.

Here, it has been shown that 6 parameters, optionally plus one datum, per line function are sufficient in order the essential information content of the base symbol matrix or of the camera image on the way to the at least one degree of freedom is sufficient so that the amount of data in the example is reduced from 225 entries to 12 or 14 entries. The calculation of the at least one degree of freedom is thus significantly reduced in terms of effort.

A further advantage of the implementation of the present invention is that the rows and the columns of the base symbol matrix are arranged parallel to one another and regularly spaced in the code arrangement so that, by deriving the linear function in the camera image, a type of averaging over the base symbol matrix is also performed, wherein the linear functions describe averaged information of the base symbol matrix. The linear functions perform a condensation of the information while improving the information content.

The method according to the present invention thus allows a computationally efficient implementation of the method for ascertaining at least one degree of freedom of the camera relative to the code arrangement from the camera image of the camera. From an application standpoint, the ascertainment can, for example, be performed on a microcontroller, which can determine the at least one degree of freedom at least 100 times per second. In this way, it is possible to perform real-time applications using the method, e.g., in manufacturing.

In a preferred development of the present invention, the first linear function is determined on the basis of at least two rows, preferably more than two rows, in particular on the basis of all rows, of the base symbol matrix. Alternatively or additionally, the second linear function is determined on the basis of at least two columns, preferably more than two columns, and in particular all columns of the base symbol matrix. This development underscores that the linear function comprises averaged and/or condensed information about multiple rows or columns.

In a preferred specific embodiment of the present invention, a first fitting line per row is formed for the rows along the first main direction. The first linear function is formed on the basis of a plurality of the first fitting lines. By a row forming a first fitting line, this first fitting line can be adjusted to the course of the row so that the first fitting line already forms averaged and/or condensed information of the underlying row. The first linear function is formed on the basis of a plurality of the first fitting lines, wherein a second averaging or condensation is carried out thereby so that the first linear function is formed by double averaging of the original information.

Alternatively or additionally, according to an example embodiment of the present invention, a second fitting line per column is formed for the columns along the second main directions. The second linear function is formed on the basis of a plurality of the second fitting lines. By a column forming a second fitting line, this second fitting line can be adjusted to the course of the column so that the second fitting line already forms averaged and/or condensed information of the underlying column. The second linear function is formed on the basis of a plurality of the second fitting lines, wherein a second averaging or condensation is carried out thereby so that the second linear function is formed by double averaging of the original information.

In a preferred implementation of the present invention, the first function argument is designed as an integer first count value of the rows and/or the second function argument is designed as an integer second count value of the columns. For an integer first count value in the first linear function, the first straight line thus corresponds to a first fitting line.

For an integer second count value as a second function argument in the second linear function, the second straight line corresponds to one of the columns of the base symbol matrix in the same way. However, the first straight line and/or the second straight line is not exactly the first fitting line or the second fitting line since the linear function has passed through the second averaging/condensation so that it is a corrected first fitting line or corrected second fitting line.

In a preferred implementation of the present invention, the fitting lines are described by a line angle as an angle of intersection and at least one axis intersection point with a or the coordinate system of the image sensor and/or of the camera image. For the fitting line, the line angle and the axis intersection point of at least or exactly one coordinate axis of the coordinate system are sufficient to determine the fitting line unambiguously in the coordinate system.

This implementation reduces the positions of the fitting lines in the dot raster of the associated row or column to two values.

In a preferred development of the present invention, the linear function is formed by a combination of a line angle function of the line angle as a function of the function argument of the linear function and the axis intersection point function of the axis intersection point as a function of the function argument of the linear function. The linear function is thus also determined by the line angle and at least one axis intersection point.

It is preferred that the line angle function is designed as a second-order polynomial and/or the axis intersection point function is designed as a second-order polynomial, wherein the polynomials have the function argument of the corresponding linear function as a function argument. This achieves that the line angle and/or the axis intersection point can be determined as a function of the function argument. The selection as a second-order polynomial makes the approximation particularly simple to perform so that the computational efficiency is further increased.

In a preferred specific embodiment of the present invention, the axis intersection point of the coordinate axis of the coordinate system that results in a smaller angle to a normal to the particular coordinate axis is selected as a function of the line angle of the linear function with the coordinate system.

Furthermore, a datum, which encodes the selected coordinate axis, is assigned to the linear function. A consideration in this respect is that only the axis intersection point of a single coordinate axis is necessary to describe the straight line, and not the axis intersection points with both coordinate axes. In order to achieve the maximum explanatory power, the axis intersection point whose assigned angle of intersection is more perpendicular to the intersected coordinate axis is selected.

In a development of the present invention, the coarse position of at least one of the base symbols in the code arrangement is determined on the basis of the base symbols of the base symbol matrix or a subset thereof. In particular, a reading field is defined in the camera image and/or the planar dot raster and a base symbol matrix corresponding thereto is formed, wherein an entry in the base symbol matrix is assigned to each point in the reading field, wherein the position and the, in particular normalized, area or the datum of the base symbols is entered in the base symbol matrix, wherein the coarse position of the coordinate system of the dot raster and/or of at least one base symbol in the code arrangement is ascertained as the two degrees of freedom on the basis of the base symbol matrix.

Preferably, the first axis intersection point function in the coordinate system of the camera image is formed by a first straight line. In the coordinate system of the code arrangement, the first straight line is aligned parallel to the first main direction of the dot raster. The axis intersection point function has the first function argument, wherein changing the first function argument shifts the first straight line parallel in the second main direction in the coordinate system of the code arrangement. The first axis intersection point function defines, as a function of the first function argument, a first axis intersection point along a first axis of the coordinate system of the camera image, wherein the first axis passes through the reference point. Shifting the first straight line by changing the first function argument in the coordinate system of the code arrangement thus shifts, in a perspectively distorted manner, the first straight line in the coordinate system of the camera and/or of the camera image such that the axis intersection point moves along the first axis.

Furthermore, according to an example embodiment of the present invention, the second axis intersection point function in the coordinate system of the camera image is preferably formed by a second straight line. In the coordinate system of the code arrangement, the second straight line is aligned parallel to the second main direction of the dot raster. The axis intersection point function has a second function argument, wherein changing the second function argument shifts the second straight line parallel in the second main direction in the coordinate system of the code arrangement. The second axis intersection point function defines, as a function of the second function argument, a second axis intersection point along a second axis of the coordinate system of the camera image, wherein the second axis passes through the reference point. Shifting the second straight line by changing the second function argument in the coordinate system of the code arrangement thus shifts, in a perspectively distorted manner, the second straight line in the coordinate system of the camera and/or of the camera image such that the axis intersection point moves along the second axis.

On the basis of the axis intersection point functions, the first and the second function argument are determined such that the reference point forms the first and the second axis intersection point. Illustratively speaking, the first function argument is varied until the first straight line in the coordinate system of the camera and/or of the camera image passes through the reference point and/or the first axis intersection point is located on the reference point. In the same way, the second function argument is varied until the second straight line in the coordinate system of the camera and/or of the camera image passes through the reference point and/or the second axis intersection point is located on the reference point.

Subsequently, on the basis of the first and the second function argument and the coarse position, the fine position of the reference point in the coordinate system of the code arrangement in the plane of the code arrangement is determined as a degree of freedom. Conceptually, the coarse position of the base symbol in the coordinate system of the code arrangement is determined first, and a shift of the base symbol to the reference point is subsequently determined on the basis of the function arguments.

The method of the present invention has the advantage that the coarse position of the base symbol can be determined by decoding the code arrangement. Subsequently, the shift to the reference point is calculated on the basis of the axis intersection point functions, wherein the calculation can be performed with few calculated values and thus computationally efficiently by using the axis intersection point functions. This has the advantage that the method can also be performed in real-time applications with digital data processing device, in particular microcontrollers, with low computing power.

In a preferred embodiment of the present invention, the first function argument is designed as a count value of the rows and/or the second function argument is designed as a count value of the columns in the dot raster. Illustratively speaking, the position of the base symbol, whose coarse position is known, is shifted to the reference point by whole steps or partial steps of the raster spacing of the dot raster.

As discussed above, the reference point is particularly preferably designed as a point of intersection of the optical axis of the camera with the image sensor. The reference point is thus defined as a constructive position in the coordinate system of the camera and/or of the camera image. However, it is not absolutely necessary that the reference point and/or the point of intersection is arranged precisely centrally in the camera image and/or on the image sensor of the camera. Rather, the position of the reference point can be defined via a calibration.

In a possible embodiment of the present invention, the axis intersection point function is designed as the linear function for describing the straight line, in particular as described above. In this case, the axis intersection point function comprises a full mathematical description of the straight line as a function of the particular function arguments.

Alternatively, a linear function, in particular as described above, is used, which is formed by a combination of a line angle function of the line angle as the angle of intersection of the straight line with one of the axes of the coordinate system of the camera image as a function of the function argument and the axis intersection point function. The straight line is thus completely described by an axis intersection point and a line angle. This division has the advantage that, for determining the fine position, only the axis intersection point function has to be determined and/or evaluated, namely, without information on the line angle. This embodiment further increases the efficiency of the method.

On the basis of the function arguments and a known raster spacing of the dot raster, the fine position can then be determined. Illustratively speaking, the fine position is determined such that, for example, starting from the position of the base symbol with the known coarse position, a move by a fraction of a raster spacing in the first main direction and a fraction of the raster spacing in the second main direction is necessary to reach the reference point in the coordinate system of the code arrangement. This representation is particularly computationally efficient.

According to an example embodiment of the present invention, it is preferably provided that the first and/or the second function argument of the linear function is determined such that the first and/or the second straight line intersects the reference point. For example, by varying the function argument, the first and the second straight line are shifted such that they intersect the reference point.

An angle of rotation Phiz of the camera about the optical axis is optionally derived as a degree of freedom of the camera relative to the code arrangement on the basis of the first and/or the second straight line, which intersect the reference point. Derivation is possible since the linear functions are defined in the camera image. It is thus possible to determine the angle of rotation Phiz as the line angle in the coordinate system of the camera and/or of the camera image. Theoretical considerations have shown that the line angle in the coordinate system of the camera and/or of the camera image corresponds to the angle of rotation Phiz of the camera about the pivot axis, namely, without a transformation of the coordinate systems from the coordinate system of the camera and/or of the camera image to the coordinate system of the code arrangement having to be performed. On the basis of at least one linear function, it is thus possible to determine the angle of rotation Phiz in a simple manner. The development thus shows a way of how the angle of rotation Phiz can be determined with maximum accuracy and without high computational effort. It should be emphasized that the determination is particularly straightforward if the point of intersection of the optical axis of the camera through the camera image or through the image sensor is selected as a reference point. In this particular constellation, the angle of rotation Phiz can be particularly easily derived. The method thus allows simple and at the same time highly accurate determination of the angle of rotation Phiz from the camera image, which angle of rotation is then available as a degree of freedom of the camera relative to the code arrangement.

In a preferred embodiment of the present invention, the base symbol matrix is ascertained from the camera image, wherein the position of the base symbols in the camera image is entered in the base symbol matrix. A position in the base symbol matrix thus refers to the position of the base symbol in the dot raster, in particular in a coordinate system of the image sensor and/or in a coordinate system of the camera image. The first and/or the second linear function is preferably determined on the basis of the base symbol matrix.

Particularly preferably, according to an example embodiment of the present invention, a linear function is used in each case, which is formed by a combination of a line angle function of the line angle as the angle of intersection of the straight line with one of the axes of the coordinate system of the camera image as a function of the function argument and an axis intersection point function. The axis intersection point function defines an axis intersection point along an axis of the coordinate system of the camera image as a function of the first function argument, wherein the axis passes through the reference point. Shifting the straight line by changing the first function argument in the coordinate system of the code arrangement thus shifts, in a perspectively distorted manner, the straight line in the coordinate system of the camera and/or of the camera image such that the axis intersection point moves along the first axis. The one linear function or the combination of the line angle function and the axis intersection point function is assigned to the first main direction, and the other linear function or the combination of the line angle function is assigned to the second main direction. The advantage of the division is that the function argument can be determined via the axis intersection point function, and the angle of rotation Phiz can subsequently be read from the line angle function on the basis of the determined function argument.

In a preferred development of the present invention, a first value for the angle of rotation Phiz is determined from the first linear function, and a second value for the angle of rotation Phiz is determined from the second linear function, and the angle of rotation Phiz is subsequently determined as the average value of the two values. Independently determining the angle of rotation Phiz from the two linear functions results in two independent values, which can then be averaged to ascertain the angle of rotation Phiz in order to improve the measurement accuracy. Alternatively, a plausibility check can also be performed, and one of the two values can be discarded if this value is not plausible or not valid.

A or the reference point is arranged in the camera image. The reference point is designed as a point of intersection of the optical axis with the image sensor and/or with the camera image.

The reference point is thus specified by the camera in the coordinate system of the camera and/or in the camera image.

In a preferred development of the present invention, the following values at the reference point are determined as characteristic values from the camera image:

A or the angle of rotation Phiz, also called Z angle of rotation, of the camera about the optical axis of the camera is determined. The angle of rotation phiz may particularly preferably be determined via the linear function and/or the axis intersection point function.

Furthermore, according to an example embodiment of the present invention, at least one or the local raster spacing of the dot raster in the camera image is determined. The local raster spacing indicates the distance between two neighboring straight lines of the dot raster in the camera image. The local raster spacing may particularly preferably be determined via the the linear function and/or the axis intersection point function. The dot raster in the code arrangement is formed regularly and/or with a regular raster spacing. By capturing the code arrangement with the camera, which results in the camera image, the raster spacing is imaged distorted so that the raster spacing across the camera image changes. The expression “local raster spacing at the reference point” is understood to mean the value of the raster spacing at the reference point.

Furthermore, according to an example embodiment of the present invention, at least a first and a second local angular divergence of the dot raster in the camera image are determined.

In principle, the straight lines in the dot raster in the code arrangement are arranged parallel to one another. However, by imaging the code arrangement in the camera image, the dot raster is distorted so that the straight lines in each case form a difference angle unequal to 0 between two neighboring straight lines. The expression “local angular divergence of the dot raster in the camera image” is understood to mean the difference angle between two neighboring straight lines of the dot raster at the reference point. This is a first local angular divergence for the first main direction and a second local angular divergence for the second main direction. The first and the second local angular divergence can in particular be determined via the linear function and/or via the line angle function.

From a physical point of view, the mentioned characteristic values completely describe three degrees of freedom of the camera relative to the code arrangement, namely, a distance rz between the code arrangement and the camera at the reference point and/or along the optical axis as well as two pitch angles phix and phy, which describe an angle between the optical axis and the plane of the code arrangement in the first and in the second main direction. The mentioned characteristic values are thus sufficient to determine the mentioned three degrees of freedom.

A further consideration in this respect is that the mentioned characteristic values can be determined in a simple manner from the camera image. In addition to a “manual” determination of the characteristic values in the camera image, it is also possible to derive these values via digital image processing methods.

Knowing the characteristic values, the three degrees of freedom mentioned can be deduced.

By selecting the mentioned characteristic values, a new method for determining the mentioned degrees of freedom is thus provided, which is characterized by the use of only a few characteristic values for determining the degrees of freedom.

This makes it possible to design the method to be computationally efficient and highly accurate.

In a preferred embodiment of the present invention, the mentioned characteristic values are used in an imaging model, which describes the optical projection of the code arrangement onto the image sensor, taking into account the position and orientation of the camera relative to the code arrangement.

The model describes the physical and thus analytical relationship between the mentioned characteristic values as input values and the three mentioned degrees of freedom as the output values. This relationship thus leads to the determination of the three degrees of freedom.

In a possible embodiment of the present invention, three equations, which form a system of equations, are determined for the three degrees of freedom. It should be emphasized that the three equations represent possible representations of the analytical relationships between the characteristic values and the three degrees of freedom; other mathematical or analytical representations are possible. However, via the three equations and/or the system of equations, the physical relationship can be represented particularly simply and compactly.

The equation for determining the first pitch angle phix is in particular a function of the first local angular divergence dalphac0, the distance rz between the code arrangement and the camera, and the second pitch angle phiy.

In particular, the first pitch angle is determined via the following equation:

$$tan {φ}_{X} = \frac{- d {α}_{C 0} \cdot {r}_{Z}}{{c}_{g r i d} \cdot {cos}^{2} {φ}_{Y}} with {c}_{g r i d} : raster spacing of the dot raster in [ m ]$$

The equation for determining the second pitch angle phiy is in particular a function of the second local angular divergence dalphac1, the distance rz between the code arrangement and the camera, and the first pitch angle phix.

In particular, the second pitch angle is determined via the following equation:

$$tan {φ}_{Y} = \frac{- d {α}_{C 1} \cdot {r}_{Z}}{{c}_{g r i d} \cdot cos {φ}_{X}}$$

The equation for the distance rz between the code arrangement and the camera is in particular a function as follows:

| | | |
|---|---|---|
| Alt. 1: rot_status = 0 | ${r}_{z 00} = \frac{b \cdot {c}_{grid} \cdot cos {φ}_{Y}}{{g}_{C 0} \cdot ( cos {φ}_{Z} - tan {φ}_{X} sin {φ}_{Y} sin {φ}_{Z} )}$ | ${r}_{z 10} = \frac{b \cdot {c}_{grid} \cdot cos {φ}_{X}}{{g}_{C 1} \cdot cos {φ}_{Z}}$ |
| Alt. 2 rot_status = 1 | ${r}_{z 01} = \frac{b \cdot {c}_{grid} \cdot cos {φ}_{Y}}{{g}_{C 0} \cdot ( - sin {φ}_{Z} - tan {φ}_{X} sin {φ}_{Y} sin {φ}_{Z} )}$ | ${r}_{z 11} = \frac{b \cdot {c}_{grid} \cdot cos {φ}_{X}}{{g}_{C 1} \cdot sin {φ}_{Z}}$ |

With
   b: image width of the camera in [m]
   g_{C0}, g_{C1}: local raster spacing of the dot raster in the camera image, in [m]

The columns relate to two independent variants and the rows relate to two alternatives depending on the definition and/or convention of the angle of rotation Phiz.

Alternatively or additionally, the distance between the code arrangement and the camera is determined as the average value of the variants and/or functions with the following equation:

$${r}_{Z} = \frac{{r}_{Z 0 k} + {r}_{Z 1 k}}{2}$$

In principle, the system of equations can be solved analytically. In a preferred development of the present invention, the system of equations comprising the three equations is solved iteratively. In this case, start values are specified first, and the degrees of freedom are then determined in iterative steps in an optimization routine.

Preferably, according to an example embodiment of the present invention, a starting field is determined as part of the method.

The starting field comprises at least three, preferably neighboring, base symbols, which are arranged at an angle to one another. The connecting lines between the base symbols of the starting field define two independent main directions along the dot raster in the camera image. In the case that the starting field has exactly three base symbols, they are arranged at an angle to one another, for example. They define a coordinate system of the planar dot raster, wherein one of the at least three base symbols forms the origin of the coordinate system. In a preferred development of the present invention, the starting field comprises nine base symbols, which are arranged in a square and/or rectangular manner. In particular, the starting field has an edge length with three base symbols. The base symbols of the starting field are valid base symbols. The term “valid base symbols” is in particular understood to mean the base symbols that, as part of the method, are selectively defined as valid or classified as valid base symbols due to image features and/or are set as valid by finding the base symbols and successfully processing the base symbols with a usable processing result. Image structures that are not classified as valid base symbols are interpreted as image interference and are excluded from further processing.

According to an example embodiment of the present invention, in the method, a search for further, in particular valid, base symbols along the main directions is carried out in a searching step, starting from at least one valid base symbol.

In the case of a successful search, in particular when finding further base symbols, the further base symbols are marked as valid base symbols.

It is provided that the searching step is performed multiple times. In the case that new further base symbols have been found as valid base symbols in a searching step, the searching step is selectively carried out from the base symbol of the starting field or from the newly found valid base symbols. In this way, starting from the starting field with valid base symbols, the dot raster is supplemented step by step by further valid base symbols. The searching step is repeated until a sufficient number of valid base symbols has been found, in particular so that decoding can be carried out.

On the basis of the valid base symbols or a selected subset thereof, the coarse position of at least one of the base symbols in the code arrangement is determined, in particular by decoding the valid base symbols, as two degrees of freedom of the camera relative to the code arrangement.

In particular, the valid base symbols or a subset thereof are decoded, wherein at least one degree of freedom of the camera relative to the code arrangement is ascertained from the decoded coarse position and, optionally additionally, coarse orientation of the coordinate system of the dot raster in the camera image.

A further consideration in this respect is that the base symbols can be searched for and found in the code arrangement and/or in the camera image, for example with area-based image processing functions. However, finding base symbols, for example, with a blob analysis or pattern-based search (pattern matching) requires frequent access to the pixels of the camera image and, as a result, leads to complex image processing.

In that, starting from the search field, which defines the two main directions of the dot raster and thus the dot raster, in particular the coordinate system of the dot raster, in the camera image, searching takes place exclusively in the main directions, the a priori knowledge about the structure of the dot raster can be used so that the search does not take place in an area-based manner but in a line-based manner along the main directions. From a practical standpoint, it is sufficient to search for a further base symbol in the main direction along a line, starting from a valid base symbol. It is clear that reducing an area search to a line search significantly reduces the number of pixel accesses and/or the image processing effort.

The method according to the present invention thus allows for a very efficient implementation of the method.

In a preferred development of the present invention, the center position, in particular the centroid position, of the base symbol in the camera image is determined for each of the base symbols. A plurality of points of intersection in the dot raster is thus ascertained on the basis of the valid base symbols.

According to an example embodiment of the present invention, it is provided that the searching step is performed starting from the center position of the particular valid base symbol, in particular a line-based search in a specified search direction, specifically along one of the main directions. While finding a base symbol initially only allows for an approximate determination of the position of the base symbol in the dot raster and/or camera image, the exact position in the dot raster and/or camera image is ascertained by detecting the center position and the dot raster is thus specified. It is advantageous that the, in particular line-based, searching step is carried out from the center position of the base symbol, since this prevents neighboring base symbols from being missed accidentally.

In a preferred development of the present invention, two connecting vectors in the two independent main directions along the dot raster in the camera image are determined on the basis of the starting field and/on the basis of further valid base symbols. By determining the connecting vectors, starting from the known valid base symbol, the position of the searched-for nearest and/or neighboring base symbol can be estimated by extrapolation as part of a linear combination of the connecting vectors.

Particularly preferably, according to an example embodiment of the present invention, the center position of a base symbol is determined such that a starting point in the base symbols is shifted to a center position along the main directions via multiple intermediate steps until the center position is found as the position in which the center position is centrally arranged in the base symbol in the main directions. By shifting the starting position to the center position such that it is always centered in the main directions, it is only necessary, for each shifting step, to find the boundary of the base symbol in the main directions and subsequently shift the starting position to the center between the boundaries.

In the example of a circular base symbol, starting from a starting position within the base symbol, a line-based search is used to search for the boundary of the base symbol in a first main direction of the camera image and subsequently to search for the boundary of the base symbol in the negative first main direction. The averaging of the boundaries leads to a more accurate position estimate. This step is repeated analogously for the second main direction and subsequently again for the first main direction.

In this way, the shift from the starting position to the center position is carried out computationally efficiently by a sequence of line evaluations along the main directions.

In a subsequent step, the area of the base symbols in the camera image is determined, wherein the area forms a datum of the encoding of the code arrangement. In particular, the area is used to classify the base symbol.

For example, the datum in the binary system can be 0 or 1, wherein the base symbols are, for example, circular areas of different sizes. In the case that the center position and, through the shifting steps, the extent of the base symbol in the main directions are known, these values can easily be used to deduce the area of the base symbol. First, the center position in the dot raster and, subsequently, the area of the base symbol are thus determined in a very computationally efficient manner.

According to an example embodiment of the present invention, the area of the base symbol in the camera image is strongly influenced by the perspective distortion. For example, the area decreases with increasing distance of the camera from the base symbol and with increasing tilt angle of the camera (elliptical distortion). These influences can lead to erroneous classification, for example if similar base symbols with a greatly different distance from the camera occur in a camera image. The normalized area of the base symbol is therefore preferably used to classify the base symbol.

For calculating the normalized area, a reference area is ascertained, which is subject to approximately the same perspective distortions as the base symbol. A parallelogram, which is spanned by the two vectors from the raster position of the base symbol to the raster positions neighboring in the major axis direction is used as the reference area. The reference area results as the magnitude of the cross product of the two vectors.

The normalized area of the base symbol is in particular calculated as the quotient of the area of the base symbol and the reference area.

In a preferred embodiment of the present invention, a reading field is defined in the camera image and/or in the planar dot raster, and a corresponding two-dimensional base symbol matrix, in particular dot matrix, is formed, wherein each point in the reading field is assigned an entry in the base symbol matrix, and wherein the position and area and/or the datum of the base symbols is entered in the base symbol matrix. From the data in the base symbol matrix, the coarse position and, optionally additionally, the coarse orientation of the coordinate system of the dot raster can be decoded and/or the coarse position of at least one base symbol in the code arrangement can be ascertained as the two degrees of freedom.

In a preferred development of the present invention, at least one start position is defined in a preliminary step for creating the starting field. The start position is defined arbitrarily.

Preferably, the start position is arranged near or neighboring the point of incidence. In the case that the start position happens to be located within a base symbol, the start position is taken as the starting position for a starting base symbol. In the case that the start position is outside a base symbol, a search for a neighboring base symbol is carried out along search rays, starting from the start position as the starting base symbol. Thus, even in the preliminary step, no computationally intensive, area-based image processing takes place; rather, starting from the start position, a search for a base symbol is carried out only along the search rays. For example, the boundary of the base symbol can be detected through a contrast change along the search direction in the camera image. It is possible that the method uses at least or precisely 8 or 16 search rays, which start at the start position and are arranged in regular angular steps distributed over 360°. A minimum radius beyond which a search for a further base symbol is carried out can be defined for the search rays. Optionally, a maximum search radius can be defined, wherein the start position is discarded and an alternative start position is selected if the maximum search radius is reached without finding a neighboring base symbol.

In a subsequent step, a search for a neighboring base symbol as a first auxiliary starting base symbol is carried out, starting from the position of the starting base symbol along further search rays. Searching from the first auxiliary starting base symbol can be performed with the same distribution of the search rays as described above.

In a subsequent step, a search for a second auxiliary starting base symbol is carried out, starting from the starting base symbol and the first auxiliary starting base symbol in a direction that is angled to the connection (and/or along a first main direction) between the starting base symbol and the first auxiliary starting base symbol. However, in this case, fewer search rays can be used than before, which search rays are in particular distributed over a smaller angular range so that the search is accelerated. This exploits the fact that the first three base symbols should be arranged at an angle to one another so that there is an a priori knowledge as to the direction in which the search for the second auxiliary starting base symbol is carried out. For example, only one, two, or three to six search rays are used, which are distributed around a main search direction that is oriented perpendicular to the connection between the starting base symbol and the first auxiliary starting base symbol.

For completion, starting from the starting base symbol, a search for all base symbols that are, in particular directly, neighboring the starting base symbol in the major axis direction or the diagonal direction of the dot raster is carried out on the basis of the connection between the starting base symbol and the first auxiliary starting base symbol and the connection between the starting base symbol and the second auxiliary starting base symbol by linear combination of the connections.

In particular, the connecting vectors and/or main directions can be derived via the first three base symbols found. They span a two-dimensional coordinate system of the dot raster. For improving the method, the center positions can be determined in order to define the connecting vectors as accurately as possible. The result is a starting field with 3×3 valid base symbols.

According to an example embodiment of the present invention, in the searching step, a search for neighboring base symbols is carried out, starting from the starting field and/or the further valid base symbols found by a previous searching step. The method preferably searches for base symbols at raster points that have at least two valid neighbors in the main directions or in the diagonal directions. All neighbors of a raster point provide, by extrapolation, independent position estimates that result in a more accurate position estimate of the raster point by averaging.

The condition that the search is only for raster points and/or for those with at least two valid base symbols as neighbors also favors an area-based extension of the detected region and avoids the line-based extension in the form of lances, dendrites or spikes. The area-based extension is more robust and more tolerant to interference in the image than the line-based extension. The base symbol matrix, in particular of the reading field, is ascertained on the basis of the valid base symbols.

In particular, it can be provided in the method that a camera image is first captured by the camera, at least one degree of freedom of the camera relative to the code arrangement is subsequently determined, and an actuator of the automation arrangement is subsequently controlled, for example. The at least one degree of freedom may, for example, be output on an optical output device, such as a display. The at least one degree of freedom may be used for position control and/or position regulation of the actuator of the automation arrangement by using it as the actual value. For example, a robot with the sensor unit of the automation arrangement may determine its absolute pose relative to the code arrangement and may output it as actual information or may drive to a specifiable further position, wherein the robot continues to orient itself with regard to its actual position by the code arrangement.

A further subject matter of the present invention relates to a control unit and/or an automation arrangement with the control unit, wherein this control unit is designed to perform the method of the present invention as described above. Optionally, the control unit comprises the camera and/or is connected to it by data technology.

A further subject matter of the present invention relates to a computer program designed to perform the above-described method when the computer program is executed on a digital data processing device and/or on the control unit.

A further subject matter of the present invention relates to a machine-readable storage medium with the computer program.

Further features, advantages and effects of the present invention arise from the following description of preferred exemplary embodiments as well as the figures.

### BRIEF DESCRIPTION OF THE DRAWINGS

FIG. 1 shows a flowchart of the entire method with an exemplary embodiment of the method according to the present invention.

FIG. 2 shows a schematic representation of the optical model in 3D.

FIG. 3 shows a schematic representation of the optical model in 2D.

FIG. 4 shows a schematic representation of the optical model in 2D.

FIG. 5, 6, 7 show a schematic illustration of the coordinate systems.

FIG. 8 shows a schematic illustration of the coordinate system for the imaging model.

FIG. 9 shows the imaging model of FIG. 8 with the code plane tilted.

FIG. 10 shows an illustration of the code arrangement.

FIG. 11 shows a further illustration of the code arrangement.

FIG. 12 shows a dot raster of a code arrangement with two reading fields drawn by way of example.

FIG. 13 shows various angular positions of the reading field.

FIG. 14 shows an example of a reading field.

FIG. 15 shows an exemplary structure of a parcel in the code arrangement.

FIG. 16 shows further exemplary structures of a parcel in the code arrangement.

FIG. 17 shows a flowchart of a validity check.

FIG. 18 shows details of the validity check.

FIG. 19 shows an exemplary camera image with an identified starting basis and the reading field.

FIG. 20 shows an example of a base symbol matrix with an entered datum of the area.

FIG. 21 shows a flowchart for determining the starting basis, according to an example embodiment of the present invention.

FIG. 22 shows multiple predefined start positions in the image field of the camera.

FIG. 23 shows an illustration of the method for determining the starting basis, according to an example embodiment of the present invention.

FIG. 24 shows an illustration of the method for determining the starting basis, according to an example embodiment of the present invention.

FIG. 25 shows a flowchart of the function Center_Pos.

FIG. 26 shows illustration of the function Center_Pos (showing steps a-h).

FIGS. 27A and 27B shows an illustration of the function Nearest dot.

FIG. 28 shows a flowchart for the sequence for detecting all dots/base symbols in the reading field;

FIG. 29A-29D show an illustration of the sequence for detecting all dots/base symbols in the reading field.

FIG. 30 shows an illustration of the detection of base symbols in a distorted raster.

FIG. 31 shows an illustration of the rectification.

FIG. 32 shows a flowchart for classifying the base symbols.

FIG. 33 shows a flowchart for determining the coarse position.

FIGS. 34A and 34B show a base symbol matrix with entered datum and with reading paths.

FIG. 35 shows an illustration of the decoding of the coarse position.

FIG. 36 shows an illustration of the fitting lines for the linear function.

FIG. 37 shows an illustration of the line angle.

FIG. 38A-38C show an illustration of the fitting lines and the linear function.

FIG. 39 shows illustration of the determination of the fine position and the angle of rotation phiz (Z angle of rotation).

FIG. 40 shows a flowchart for determining the camera distance and the pitch angle.

### DETAILED DESCRIPTION OF EXAMPLE EMBODIMENTS

A method of the present invention is disclosed as the implementation of an algorithm for precisely determining the absolute 6D position of a camera 1 in relation to a planar code arrangement 2 captured by the camera 1, wherein the algorithm receives a camera image 3 as input information.

The code arrangement 2 is simultaneously used as an analog and digital scale in two dimensions, X and Y. It consists of symbols arranged in a regular raster. This is preferably a binary code with two symbols arranged in a square raster: a small circular dot for a digital 0 and a large dot for a 1. The dot type contains the digital information, while the dot center contains the analog information.

The camera 1 detects a portion of the code arrangement 2 and transmits the camera image 3 to a computer or any data processing device. The algorithm selects a reading field in the camera image 3 with the minimum size of a code cell (e.g., 7×7 dots) and calculates the position of the camera 1 in relation to the code arrangement 2 in six dimensions therefrom. For this purpose, the method uses both the digitally encoded position information and the precisely measured center positions of all dots in the measurement field or the reading field. They form a raster, which is distorted by the camera perspective and the distortion by the objective.

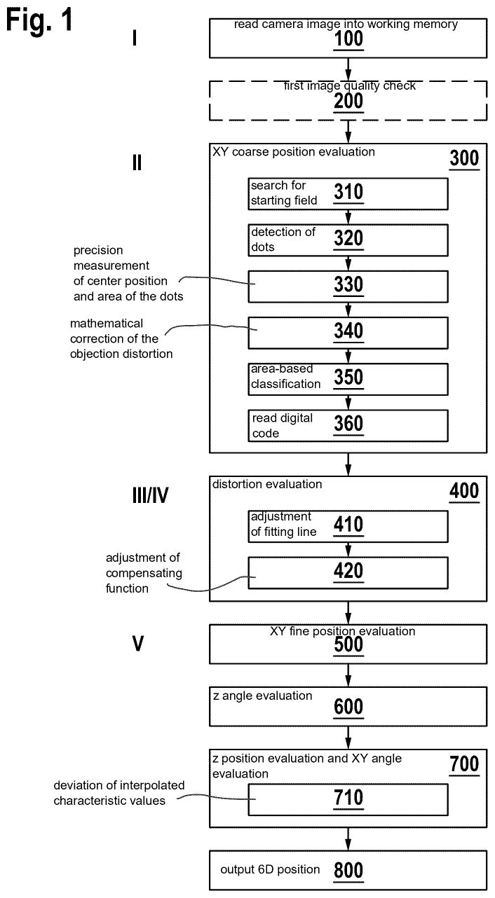

The position detection method comprises the following steps (see FIG. 1):
Step 100: Reading of the camera image 3 into the working memory of the computer.
Step 200: Optionally: First image quality check on the basis of characteristics such as brightness and contrast.
Step 300: XY coarse position evaluation and optionally z coarse angle evaluation
Step 310: Search for a starting field (launch pad) of 3×3 dots in the reading field
Step 320: Detection of the dots in a reading field in the camera image
Step 330: Precise measurement of the center position and area of the dots
Step 340: Optionally: Mathematical correction of the objective distortion by rectification of the dot positions. This converts the lines of the dot raster that are curved in the camera image 3 into straight lines.
Step 350: Area-based classification of the dots, assignment to the binary digits 0 and 1
Step 360: Reading of the digital code in the axis directions X and Y, determination of the absolute coarse position in the X, Y and, optionally, Az direction as a z coarse angle evaluation.
Step 400: Distortion evaluation
Step 410: Adjustment of a fitting line (beam) to each row and each column of the dot raster of the reading field
Step 420: Adjustment of a compensating function to a first line bundle (bunch) by interpolating all straight lines in the rows and of a second compensating function by interpolating all straight lines in the columns of the code raster. Each line bundle is fully described by 6 interpolation parameters (bunch data). With the aid of the interpolation function, interpolated straight lines that are located between two measured straight lines can also be calculated therefrom.

Calculation of the 6D camera position from characteristic values that are obtained from the measured dot positions and describe the distorted raster in the camera image. The equations for calculating the position result from an inverse optical imaging model of the camera 1 and the laws of geometric optics:

### Step 500: XY Fine Position Evaluation:

The position in the X and Y directions is calculated from the XY coarse position and the pose of the raster in relation to the pose of the optical axis (image center).
Step 600: Z angle evaluation from the angle of the (interpolated) straight lines in the image center
Step 700: Z position evaluation and XY angle evaluation
Step 710: Derivation of interpolated characteristic values from the bunch data describing the perspectively distorted raster in the image center:
   raster spacing of the straight lines of both line bundles
   angular divergence of the straight lines of both line bundles

The camera position in the Z direction is determined primarily from the raster spacing of the straight lines in the image center

The camera angles φ_{X} and φ_{Y} are ascertained primarily from the angular divergence of the two line bundles in the image center.

An iterative algorithm numerically solves the system of equations with which the variables Z, φ_{X} and φ_{Y} are associated.
Step 800: Output of the 6D position information and the optional validity information resulting from the results of numerous diagnostic functions in the sequence.

With minimal computational effort, the algorithm focuses the camera image data on a few data relevant to the position determination, increases the accuracy through interpolation, and behaves robustly in the case of camera image interference. Of particular importance are the following sequence positions (numerical values as an example):
Sequence position I: camera image input data (e.g., 200×200 pixels)
40,000 values
Sequence position II (step 300): converts the camera image data into dot data
2,250 values
Sequence position III (step 400/500): converts the dot data into beam data
90 values
Sequence position IV (step 400/500): converts the beam data into bunch data
12 values
Sequence position V (step 500/600/700): converts the bunch data into a 6D position
6 values

The sequence positions II-V have the following special features.

### Sequence Position II:

a) Quick finding of the dots in the camera image 3 by mathematically modeling the perspectively distorted code raster in the code arrangement 2. The method is based on the already measured dot positions.
Advantages: quick finding of the dots, eliminating the need for time-consuming searches in the pixel raster. Robust to camera image interference: Dots are classified as “not valid” if they are not found at the expected position. Non-valid dots are not further processed, but generally do not impede the further sequence

b) Stack-based algorithm for quickly and robustly searching for the dots in the code raster of the code arrangement 2.
Advantage: fault tolerant since the search method does not abort in the case of faulty dots, but rather surrounds them on all sides. Accurate (high yield of found dots per reading field) and robust (by prioritized detection of dots with many valid neighbors)

c) Function Center_Pos: fast method for subpixel-accurate position and area determination of dots in the camera image
Advantage: fast (few pixel accesses), accurate (by subpixeling), robust (use of dynamic contrast thresholds rather than grayscale thresholds)

d) Rectification of the dot positions rather than the entire camera image.
Advantage: fast (rectification of only 225 positions instead of all 40,000 pixels in the camera image)

e) Local normalization of the dot area to the area of the dot raster cell. The normalized dot area is used to classify the dots.
Advantage: robust reading of the digital code (classification of the dots is tolerant to perspective distortion and to a change in the distance between the camera and the dot)

f) Redundant reading of the digital code, error detection, and some error correction
Advantage: low error rate in the case of interference in the camera image, correct reading despite non-valid dots.

### Sequence Positions III and IV:

g) Compressed and precise representation of the dot positions extracted from the camera image 3, as bunch parameters (only 12 values)
Advantage: fast (due to low amount of data), precise (through averaging and best-fit interpolation in two stages: dots to fitting lines and fitting lines to line bundles), fault tolerant and robust (through exclusion of non-valid dots from further processing).

### Sequence Position V:

h) Mathematical method for transforming the 12 bunch parameters into a 6D position.

As advantages, some or all of the following improvements are achieved:
Full 6D position measurement, absolute position information.
Simultaneous detection of all dimensions with one measurement process (in a camera image).
High position measurement rate and low latency. The method requires only a small number of computing steps of a computer. With an embedded computer, typical measurement rates of about 100 Hz-10000 Hz are achieved so that the sensor can, for example, also be used in a closed pose control loop. The method also achieves high reading speed by minimizing the number of accesses to camera image points (pixels). No time-intensive, area-based camera image operations are performed. In addition, the amount of data is significantly reduced with each processing step.
High reading reliability through redundant reading of the dot code. The position detection is also possible in the case of interference in the image field of the camera, for example in the case of local occlusion, non-valid dots, or under unfavorable lighting conditions.

A validity check of the processing steps detects erroneous states and prevents the output of unreliable position values.
High accuracy of the position measurement in all degrees of freedom. This is achieved by various measures such as
Averaging over numerous dots per camera image 3, for example more than 100 or 1000
Classification of dots according to validity, exclusion of non-valid dots from further processing
Subpixel-accurate positioning of the edges of the dots
Use of contrast thresholds instead of grayscale thresholds, thereby achieving high robustness to local changes in image brightness
Round dots, therefore little center error in the case of tilting or rotation of the code plane.
Unlimited measurement range in φ_{Z}
Nearly unlimited measurement range in X and Y. For example, when using a code with a code cell of 9×9 dots and a dot raster of 2.5 mm, a measurement range of 550,000 km x 550,000 km is achieved.
Large angular measurement range φ_{X}, φ_{Y} of about +/−50°, with high accuracy. Extension to 360° by spatially distributed code arrangements on the object.
An inverse imaging model on the basis of the geometric optics is used to calculate the position of the camera from the camera image data.
The method does not require any active lighting, so that camera images captured under ambient light, for example with a smartphone, can be processed.
Minimum error rate. The method determines the validity of a position measurement value by checking each processing step for errors and plausibility by means of various diagnostic methods. The validity is output together with the position measurement value. The goal is to output only valid measurement values for further processing.

### Additional Advantages are:

A single measurement transducer, in particular designed as a camera 1, detects the position of one or more objects in six dimensions in each case. In comparison to a system with many distributed sensors for detecting individual degrees of freedom, installation effort and complexity of the overall system are reduced, resulting in cost advantages.
System component savings by detecting all 6 degrees of freedom. For example, a rotary encoder usually requires a pivot bearing for the measurement axis so that lateral position deviations of the code disk do not lead to measurement errors.

With the proposed method, the mechanical guide can be omitted since the full 6D pose information of the code disk is simultaneously detected as a code arrangement. A lateral position deviation of the sensor does not result in an error in the angle measurement. This reduces the cost and the mechanical complexity of the position measurement system.
It is possible to implement a positioning system in which the distribution of the position sensor technology onto multiple axes is structurally not possible. For example, it is possible to implement a levitating planar robot that can be positioned in six dimensions without a structural connection between the robot and the underlying stator.
The simultaneous detection of multiple dimensions reduces measurement errors that may arise due to different measurement points in time in distributed sensor systems.
The costs of the sensor are largely independent of the number of degrees of freedom detected. The sensor can therefore also be advantageously used in applications that require less than 6 degrees of freedom. The additionally provided information allows for additional functions, for example the self-diagnosis of systems or the permanent monitoring of the operating condition (condition monitoring). The method is scalable, e.g., by varying the raster spacing of the code arrangement and adapting the imaging optics to the code arrangement. The resolution may vary over many orders of magnitude, for example from the nanometer range (application example: nanometer positioning system) to the m range (application example: automated landing of an aircraft or drone at an airfield, with the airfield marked with a code arrangement).
The ratio of resolution to measurement range can comprise many orders of magnitude. For example, if displacement measurement system with a 10 nm resolution is combined with a code arrangement that is 10 m long, the ratio of resolution to measurement range is 1:109.
A sensor with the method is highly versatile since it can be installed easily and configured for specific applications by parameterization. This is in particular advantageous in the case of frequently changing operating conditions.
The method can read additional information included in the position code. For example, in addition to the position, object identification data can be read.
In cyclic image capture, the method provides an independent position estimate, which does not rely on prior information from previous images, for each individual image. The measurement rate therefore corresponds to the refresh rate.

The method allows for the localization of the at least one camera 1 in relation to at least one object 8 in six degrees of freedom, wherein at least one code arrangement is attached to the surface of each object 8. A camera 1 detects the code arrangements 2 on the objects 8 and represented them in full or in part in the camera image 3. Using the proposed method and further conventional mathematical/technical methods, the 6D position of the objects 8 is calculated from the camera image 3.

The code arrangement 2 forms a planar, digitally encoded scale.

It contains multiple different symbols, preferably circular symbols (dots), which are arranged in a regular, preferably square, raster and allow for position determination in 6 degrees of freedom.

The camera 1 comprises at least
An imaging sensor element, usually a camera chip, in particular the image sensor 12.
An imaging system that projects the scale with sharpness and high contrast onto the sensor element, in particular the objective 9. In particular, the imaging system comprises a wide-angle lens as an objective 9 since central perspective projection is required to determine all six degrees of freedom.
An interface for outputting the camera image data and/or the camera image 3.
Optionally, the camera system of the camera 1 comprises.
A lighting system, in particular for illuminating the code arrangements. This makes the camera 1 more independent of the lighting conditions in the environment. In flash mode, short measurement times are made possible so that even fast-moving objects can be detected. For example, light-emitting diodes are used as illuminants.
Means for shielding from external light, e.g., an aperture or optical filter. A spectral filter may be present in the ray path of the imaging system so that only light of a limited wavelength range reaches the sensor element. Ideally, monochrome illuminants with the same wavelength characteristic as the color filter are used.

In addition, a computer system as a digital data processing device for information processing, e.g., designed as a control unit, is required. It receives the digitized camera image data of the camera image 3 as input information and, at the output, it provides the ascertained 6D positions of the identified objects and, optionally, a rating of the validity of the position measurement values.

In the computer system, the method is implemented as an algorithm. The algorithm is executed either on demand from the outside or cyclically, for example in a fixed time grid for detecting the movement paths of objects (tracking).

For example, the computer system may be embodied as an embedded system, parallel computer, GPU, FPGA, ASIC, or cloud system. A smartphone can also be used as an overall system for position detection, wherein the integrated camera 1 is used for image capture, with active lighting if necessary. The method can be implemented in a smartphone application and executed embedded in the smartphone or in the cloud.

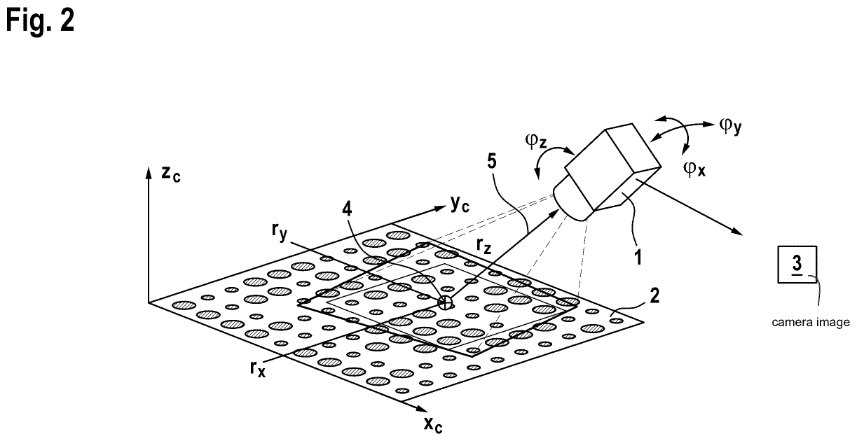

FIG. 2 shows a typical arrangement for determining the absolute position in 6 degrees of freedom. The camera 1 captures the camera image 3 of a planar code arrangement 2. From the perspectively distorted camera image 3, the method according to the present invention calculates the 6D position of the camera in the coordinate system of the code arrangement 2 and outputs it as a position vector (r_{X}, r_{Y}, r_{Z}) and angle vector (φ_{X}, φ_{Y}, φ_{Z}).

The coordinates r_{X} and r_{Y} are specified in the rectangular coordinate system (X_{C}, Y_{C}) of the code arrangement 2. They denote the point of intersection 4 of the optical axis 5 of the camera 1 with the plane in which the code arrangement is located. Since the optical axis 5 is perpendicular to the plane of the image sensor 12, it can be denoted by a point 7 in the camera image 3.

The method ascertains the point of Intersection (X, Y) even If the code arrangement 2 is shown only at the edge of the image field and not at the position of the optical axis 5.

The distance r_{Z} is located on the optical axis 5 and extends from the point of intersection 4 to the optical center of the objective of the camera 1. Since the optical axis 5 is not always perpendicular to the code arrangement 2, r_{Z} with (X_{C}, Y_{C}) generally forms a non-orthogonal coordinate system. By means of the angle vector, the position vector (r_{X}, r_{Y}, r_{Z}) can be transformed into a rectangular coordinate system.

With the method, multiple simultaneously captured objects 8 can be located in the image field of the camera even if they partially overlap. In order to be able to read the position, at least one region of the size of a code parcel (e.g., 7×7 dots) must be detectable in the camera image 3.

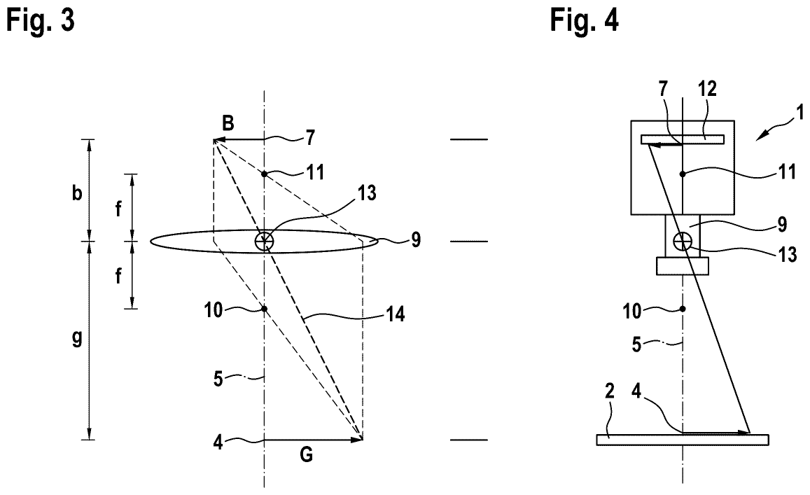

FIGS. 3 and 4 schematically show the ray path of the camera 1.

FIG. 3 shows the camera 1 with an objective 9 and an image sensor 12; the viewing direction is directed downward toward the code plane of the code arrangement 2. The optical axis 5 is drawn as a dot-dashed perpendicular line, the focal points of the objective 9 as points 10, 11.

A vector arrow G on the code plane of the code arrangement 2 Is projected as vector arrow B onto the image sensor 12 according to the laws of ray optics. A view ray 14 intersects the optical axis 5 at a point referred to here as the optical center 13 of the objective 9.

FIG. 4 shows the complete ray path; the objective 9 is simplified to a lens. The ray optics with the ray theorem and the lens equation form the basis for the mathematical method for position determination. The following applies here:

$$B / G = b / g \qquad and 1 / f = 1 / b + 1 / g$$

with:
B image size
b image width
G object size
g object width
f focal length

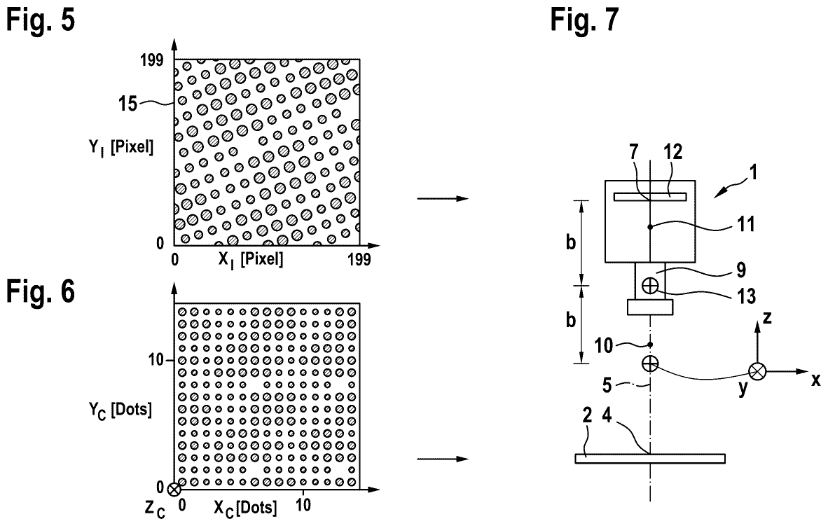

FIG. 5, 6, 7 illustrate the coordinate systems involved:

The two-dimensional coordinate system 15 of the image sensor 12 is spanned by the axes (X_{I}, Y_{I}) of the camera chip. A position on the image sensor 12 is specified in image points [pixels], wherein the pixel rows and pixel columns of the camera chip are numbered consecutively. In this example, an image sensor 12 with 200×200 pixels is assumed. The numbering results in an integer X position value and an integer Y position value for each pixel.

By subpixeling, a method for interpolating grayscale values between neighboring pixels, real numbers can also occur as a camera position during the evaluation. In order to convert the unit of the position from [pixels] to [m], the position is multiplied by the spacing between neighboring pixels p_{grid} on the camera chip in the unit [m/pixels]. The pixel spacing p_{grid} is a property of the image sensor 12. Each pixel provides an integer grayscale value.

The coordinate system 16 of the code arrangement 2 (X_{C}, Y_{C}) is spanned by the major axes of the code arrangement 2, which correspond to the square raster of the dots. A third axis Z_{C} that is perpendicular to the code arrangement 2 is used to extend the coordinate system to a three-dimensional coordinate system, wherein the code arrangement 2 is arranged at Z_{C}=0. The unit is either [dots], i.e., the consecutive numbering of the dot rows and dot columns, or [m] after multiplication by the dot raster spacing c_{grid} in [m/dot]. The code arrangement 2 unambiguously encodes the local position in the coordinate system (X_{C}, Y_{C}). The three-dimensional camera coordinate system (X, Y, Z) 17 is fixedly connected to the camera 1. Its origin is located on the optical axis 5 between the image sensor 12 and the code arrangement 2, at a distance of double the image width b from the image sensor 12. The optical axis 5 forms the Z-axis; the camera 1 points in the −Z direction.

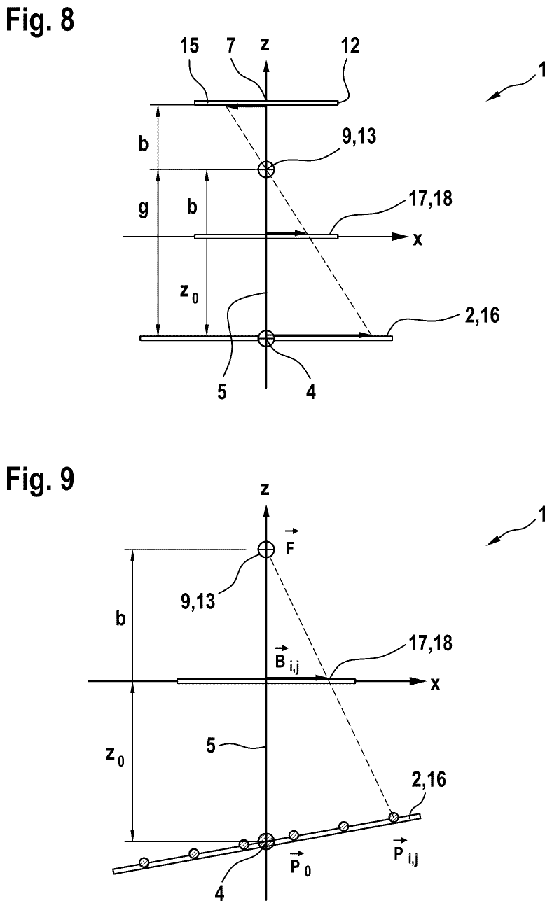

The coordinate system for the imaging model in FIG. 8 corresponds to the camera coordinate system 17 (X, Y, Z). Here, b is the image width of the camera 1. The image plane is located at height (0, 0, 2b) and is parallel to the X/Y-plane of the camera coordinate system 17. As a model concept, a further “virtual” image plane 18 can be constructed in the (X, Y)-plane of the coordinate system 17, wherein the virtual image is point-symmetrically mirrored on the image sensor 12 in relation to the image center in comparison to the real image.

The code plane of the code arrangement 2 is located at height (0, 0, z₀) with (z₀<0). In the camera orientation (0°, 0°, 0°), the code plane is parallel to the X/Y-plane of the camera coordinate system 17, and the axes (X_{C}, Y_{C}) of the coordinate system 16 of the code arrangement 2 point in the same direction as the axes (X_{I}, Y_{I}) of the coordinate system 15 of the image sensor 12.

The method ascertains the 6D position of the camera
in translation: (r_{X}, r_{Y}, r_{Z}) and
in rotation: (φ_{X}, φ_{Y}, φ_{Z}).

The center of rotation to which the tilt angle and the angle of rotation phix and phy of the camera 1 relate is located at the point (0, 0, z₀). The roll angle phiz is measured about the optical axis 5.

FIG. 9 shows the imaging model with a tilted code plane of the code arrangement 2.

The value r_{Z} is the distance between the center of rotation (0, 0, Z₀) and the optical center (0, 0, b) of the objective so that the following applies: r_{Z}=b−z₀.

Starting from the ray theorem and geometric optics, the projection of a point (x₀, y₀) in the code plane to a point (B_{X}, B_{Y}) in the image plane can be described mathematically as an imaging equation in the camera coordinate system 17:
Optical center 13 of the objective 9:

$$\vec{F} = ( \begin{matrix}0 \\ 0 \\ b\end{matrix} )$$

Two-dimensional coordinates of dots or points in the plane of the code arrangement in the coordinate system 16 of the code arrangement 2

$${\vec{P}}_{i , j}^{′} = {\vec{P}}_{0} + ( \begin{matrix}i \\ j\end{matrix} ) \cdot {c}_{grid} = ( \begin{matrix}{x}_{0} + i \cdot {c}_{grid} \\ {y}_{0} + j \cdot {c}_{grid}\end{matrix} )$$

with \vec{P}₀=(X₀, Y₀) the centroid of a selected base symbol and i, j integers.
Spatial coordinates of dots or points in the camera coordinate system 17:

$${\vec{P}}_{i , j} = [ \underline{R} ( \begin{matrix}{x}_{0} + i \cdot {c}_{grid} \\ {y}_{0} + j \cdot {c}_{grid} \\ 0\end{matrix} ) ] + ( \begin{matrix}0 \\ 0 \\ {z}_{0}\end{matrix} )$$

with the rotation matrix for vectors in three-dimensional space:

$$\begin{matrix}\underline{R} = ( \begin{matrix}{R}_{11} & {R}_{12} & {R}_{13} \\ {R}_{21} & {R}_{22} & {R}_{23} \\ {R}_{31} & {R}_{32} & {R}_{33}\end{matrix} ) \\ = ( \begin{matrix}cos {φ}_{Y} cos {φ}_{Z} & sin {φ}_{X} sin {φ}_{Y} cos {φ}_{Z} + cos {φ}_{X} sin {φ}_{Z} & sin {φ}_{X} sin {φ}_{Z} - cos {φ}_{X} sin {φ}_{Y} cos {φ}_{Z} \\ - cos {φ}_{Y} sin {φ}_{Z} & cos {φ}_{X} cos {φ}_{Z} - sin {φ}_{X} sin {φ}_{Y} sin {φ}_{Z} & cos {φ}_{X} sin {φ}_{Y} sin {φ}_{Z} + sin {φ}_{X} cos {φ}_{Z} \\ sin {φ}_{Y} & - sin {φ}_{X} cos {φ}_{Y} & cos {φ}_{X} cos {φ}_{Y}\end{matrix} )\end{matrix}$$

Image point in the virtual image plane in the camera coordinate system 17:

$$\vec{B} = ( \begin{matrix}{B}_{X} \\ {B}_{Y} \\ 0\end{matrix} )$$

View ray from \vec{F} to \vec{P}_{i,j}:

$$\vec{G} = \vec{F} + λ ( {\vec{P}}_{i , j} - \vec{F} ) \qquad ; λ = 0 . . 1$$

Point of intersection of the view ray with the virtual image plane 18:

$$\begin{matrix}( \begin{matrix}{B}_{X} \\ {B}_{Y} \\ 0\end{matrix} ) = ( \begin{matrix}0 \\ 0 \\ b\end{matrix} ) + λ [ \underline{R} ( \begin{matrix}{x}_{0} + i \cdot {c}_{grid} \\ {y}_{0} + j \cdot {c}_{grid} \\ 0\end{matrix} ) + ( \begin{matrix}0 \\ 0 \\ {z}_{0}\end{matrix} ) ( \begin{matrix}0 \\ 0 \\ b\end{matrix} ) ] \\ 0 = b + λ ( {R}_{31} ( {x}_{0} + i \cdot {c}_{g r i d} ) + {R}_{32} ( {y}_{0} + j \cdot {c}_{g r i d} ) + {z}_{0} - b ) \\ ⇒ λ = - b / ( {R}_{31} ( {x}_{0} + i \cdot {c}_{g r i d} ) + {R}_{32} ( {y}_{0} + j \cdot {c}_{g r i d} ) + {z}_{0} - b )\end{matrix}$$

Virtual image of the point or dot:

$$( \begin{matrix}{B}_{X} \\ {B}_{Y}\end{matrix} ) = \frac{- b}{( {}_{31} ( {x}_{0} + i \cdot {c}_{grid} ) + {}_{32} ( {y}_{0} + j \cdot {c}_{g r i d} ) + {z}_{0} - b )} \cdot ( \begin{matrix}{R}_{11} ( {x}_{0} + i \cdot {c}_{g r i d} ) + {R}_{12} ( {y}_{0} + j \cdot {c}_{grid} ) \\ {R}_{21} ( {x}_{0} + i \cdot {c}_{g r i d} ) + {R}_{22} ( {y}_{0} + j \cdot {c}_{grid} )\end{matrix} )$$

For the real image, the negative sign must be omitted: For the point of intersection 4 with the index (i=0; j=0), the following image coordinates in the real image are obtained:

$$( \begin{matrix}{B}_{X} \\ {B}_{Y}\end{matrix} ) = \frac{b}{( {R}_{31} {x}_{0} + {R}_{32} {y}_{0} + {z}_{0} - b )} \cdot ( \begin{matrix}{R}_{11} {x}_{0} + {R}_{12} {y}_{0} \\ {R}_{21} {x}_{0} + {R}_{22} {y}_{0}\end{matrix} )$$

### 2.4.3 Code Arrangement

The method requires an areally encoded scale in the code arrangement 2, of which a subregion is read with an imaging sensor, for example the camera 1, so that the pose of the sensor and/or of the camera 1 in relation to the scale can be ascertained in up to six spatial directions from the image information. Further details regarding the code arrangement 2 are provided in publication DE 10 2016 216 221 A1 by the applicant, the contents of which are incorporated into the present disclosure via referencing, in particular with regard to the formation of the code arrangement as well as the decoding and the variants.

The encoded scale is formed as a sensor-readable marker, is applied as a code arrangement 2 to a surface that extends substantially in two dimensions but may also have curvatures.

For a better description, it is assumed below that the encoded scale is printed as an optically readable pattern on a planar surface, without excluding other marking principles and sensor principles and curved surfaces.

The encoded scale of the code arrangement 2 is formed by the arrangement of different base symbols in a regular raster. The base symbols carry two pieces of information: their shape encodes digital information and their centroid marks a specific position on the surface.

In a simple case, the digital information is encoded in a binary number system with the base b=2. In this case, only two base symbols 20 are used, for example a small circle and a large circle, symbolizing the values “0” and “1”. Their centroid (circle center) marks a raster point on the surface.

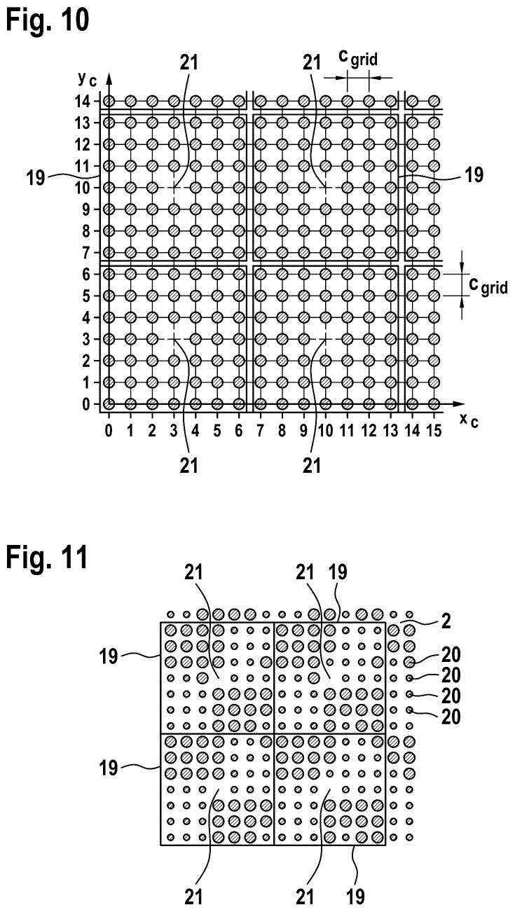

The centroids of the base symbols 20 form a periodic two-dimensional pattern on the scale plane of the code arrangement 2, for example in a square raster as in FIG. 10 with the same base spacing c_{grid} between neighboring symbols in the X and Y directions.

By dividing the plane into equally sized, area-filling parcels 19, the base symbols within a parcel 19 are grouped together into a logical unit. Preferably, square parcels 19 are used.

FIG. 10 shows a dot raster with square parcels 19 that can each receive 7×7 binary symbols, which corresponds to a maximum information content of 49 bits. The lines and squares drawn in FIG. 10 are for illustrative purposes only and are not represented in the real code arrangement 2. FIG. 11 shows an exemplary code arrangement 2 with no lines with the base symbols 20 in the parcels 19.

The regular arrangement of the base symbols 20 is superposed by a regular arrangement of parcel symbols 21 by marking each parcel 19 in the same way with a parcel symbol 21. For example, the parcel symbol 21 may be represented by omitting a base symbol 20.

In FIG. 10, 11, the parcel symbol 21 consists of an empty space located in the center of each parcel 19 in the dot raster. The parcel symbol 21 allows to detect the pose of the parcel 19 in order thereby to read the base symbols 20 along a reading path in the correct order. Since the parcel symbol 21 occupies a raster space, the information content of a parcel 19 is reduced to 48 bits in this example.

A reading field 22 is a field on the encoded scale of the code arrangement 2 that has at least the size of a parcel 19. It is bound to the dot raster but not to the raster of the parcels 19.

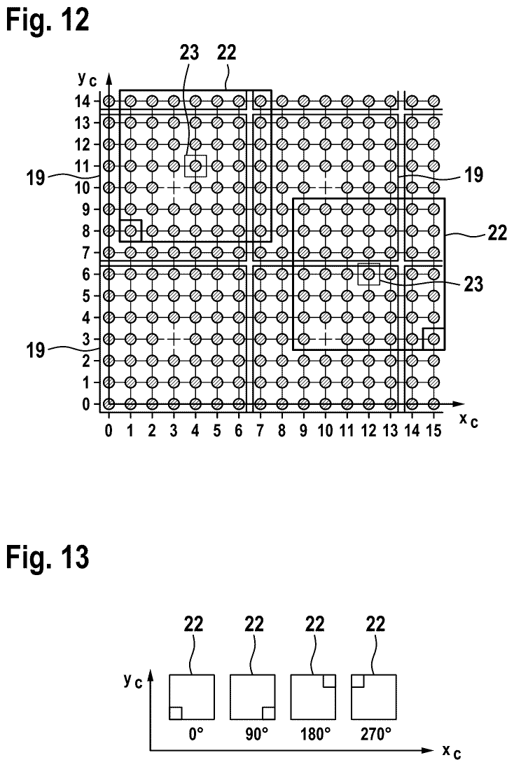

FIG. 12 shows a dot raster of a code arrangement 2 with two reading fields 22 drawn by way of example. The pose of the reading field 2 in the coordinate system of the dot raster is defined by its center position 23. It can vary in integer steps of the base spacing c_{grid}.

In addition, the reading field 22 has an angular position in relation to the coordinate system of the dot raster, which angular position may vary in steps of 90° in the case of a square raster. In FIG. 12, the angular position is visualized by the marking of a corner of the reading field. The possible angular positions are shown in FIG. 13. The reading fields 22 shown by way of example in FIG. 12 are unambiguously described by the following information:
Reading field 22, left: position=(4,11); angular position=0°
Reading field 22, right: position=(12,6); angular position=90°

The code of the code arrangement 2 is constructed such that the base symbols 20 in a reading field 22 contain sufficient information to digitally encode the position (X, Y) and the direction of the reading field 22 in the coordinate system 16 of the code arrangement 2. X and Y are specified in integer multiples of the base spacing c_{grid} (coarse position). The fine position in fractions of the base spacing c_{grid} as well as the exact angle in fractions of 90° is not digitally encoded, it is ascertained by accurately determining the position of the base symbols 20 in the camera coordinate system 17.

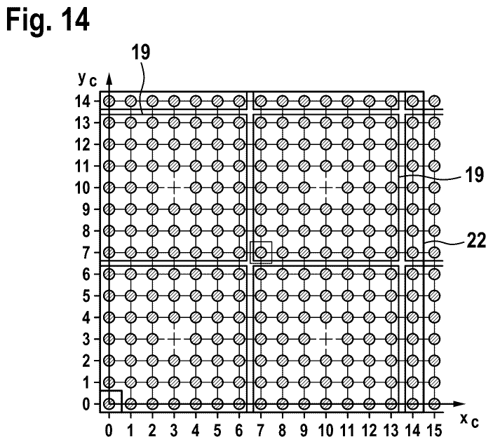

FIG. 14 shows, by way of example, a reading field 22 with 15×15 spaces for base symbols 20. It provides more information than the minimum required reading field 22 of the size of a parcel 19, here 7×7 symbols. The redundant information is used for error detection and/or error correction.

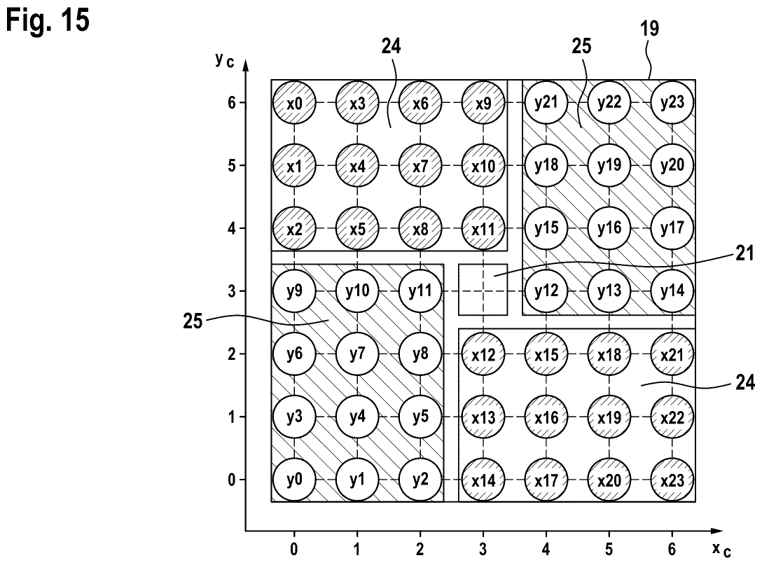

FIG. 15 shows, by way of example, the structure of a parcel 19 with 7×7 raster points. The parcel symbol 21 is located in the center of the parcel 19. The two fields 24 denote the X parcel regions in which the consecutive code for the position in the X direction is represented. The X parcel regions comprise 24 raster points; accordingly, they represent a code with a length of 24 bits.

For reading the code, the base symbols 20 are read column by column from left to right and within each column from top to bottom. The reading order in the X parcel regions 24 (reading path) in raster point coordinates (X_{C}, Y_{C}) is: (0,6); (0,5); (0,4); (1,6); (1,5); (1,4); (2,6); (2,5); (2,4); (3,6); (3,5); (3,4); (3,2); (3, 1); (3, 0); (4, 2); (4, 1); (4, 0); (5, 2); (5, 1); (5,0); (6,2); (6,1); (6,0).

The two fields 25 denote the X parcel regions In which the consecutive code for the position in the Y direction is represented. The reading order corresponds to that of the X parcel regions 24 but is rotated 90° counterclockwise. The reading path thus runs row by row from bottom to top and within each row from left to right.

The code from the X parcel regions 24 (X code) is a subsequence of a length t=24 digits from an overall sequence of g digits, wherein g is much larger than t. The number g is sufficiently large so that the X parcel regions 24 of all parcels 19 neighboring in the X direction can be completely filled. In particular, g is greater than fifty, in particular greater than a thousand and, specifically, greater than one million. The contents of the X parcel regions 24 of parcels neighboring in the Y direction are identical. The overall sequence is designed such that each subsequence of t consecutive base symbols 20 read forward is included in the overall sequence exactly once, and each subsequence read backward is not included in the overall sequence read forward.

The code from the Y parcel regions 25 (Y code) is shown inverted, i.e., each digit z is replaced by the digit (b-1-z). For the binary system with b=2, this corresponds to bitwise inversion. The inverted Y code is a subsequence of a length t=24 bits from an overall sequence, wherein the same overall sequence can be used as for the X code. The inverted Y code also occurs only once in the overall sequence and does not occur in the overall sequence when read backward. The contents of the Y parcel regions 25 of parcels 19 neighboring in the X direction are identical.

The overall sequence is designed such that a digit sum of a subsequence is less than half the maximum possible digit sum of a subsequence. In particular, for any subsequence selected from the overall sequence, the digit sum is less than half the maximum possible digit sum of a subsequence. For example, the digit sum of each subsequence of length t for a number system with base b is less than q=t·(b−1)/2.

The subsequences of the overall sequence encode a coordinate value, for example the X coordinates of the start position of the reading process. Likewise, a subsequence of the inverted overall sequence encodes a Y coordinate, for example the position from which the subsequence is read. The X code read in a parcel 19 and the Y code are assigned to the X and the Y coordinate of a reference point in the parcel 19, for example the center of the reading field.

Each reading field 22 contains exactly one parcel symbol 21, t base symbols from X parcel regions 24, and t base symbols from Y parcel regions 25. From the position of the parcel symbol 21, the pose of the parcel raster and thus the pose of the X and Y parcel regions 24, 25 in the reading field 22 as well as the associated reading order can be derived. The base symbols 20 read according to the reading order result in a sequence of digits with t digits, which is a subsequence of the overall sequence, after inversion where applicable.

If the orientation of a reading field 22 is unknown, it is initially not known which of the two axes is the X axis and which is the Y axis. This is ascertained by calculating the digit sum of the read code and comparing it to q: The digit sum of an X code is less than q, the digit sum of a Y code is greater than q. The direction of the coordinate axes of the reading field 22 in relation to the coordinate axes of the code arrangement 2 is unambiguously derived from the direction of the read codes in relation to the overall sequence (forward or backward).

In this way, the pose and orientation of a reading field 22 in the coordinate system 16 of the code arrangement 2 can be determined, the pose in integer steps of the raster width and the orientation in integer steps of 90°.

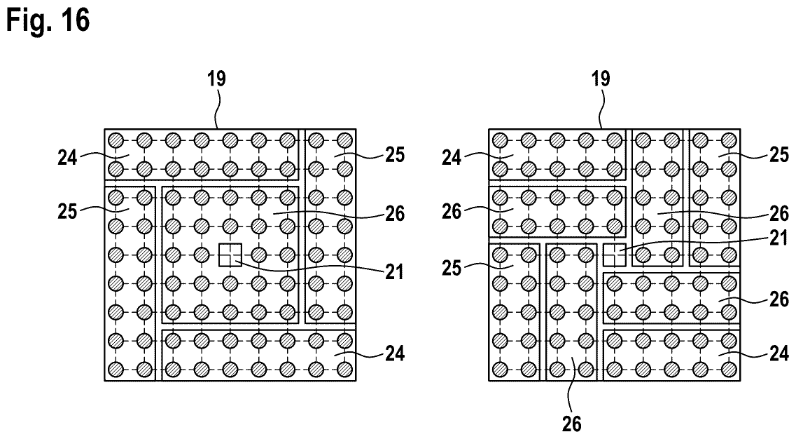

In FIG. 16, on the left, parcels 19 with 9 rows and 9 columns are shown analogously. In addition to the parcel regions X and Y 24, 25, which represent the position code for the corresponding axis of the coordinate system 16, a parcel region is provided for additional data 26. It comprises (5×5) raster points, with the center raster point for the parcel symbol 21 left empty, leaving 24 raster points, which can each accommodate a base symbol 20. In this way, 24 bits of additional information, which are not needed for the position determination and are read in a defined order, can be represented in each parcel 19. FIG. 16, on the right, shows a further code arrangement 2 with additional data. Four parcel regions 26 with 10 raster points each for additional data are provided here so that a total of 40 bits of additional information is available per parcel 19.

The position determination algorithm is shown in FIG. 1 as a sequence of data processing steps, which are explained in detail below with reference to exemplary embodiments. Standard methods of mathematics and image processing as well as diagnostics and error detection are not explained in detail.

The method is in particular optimized for high accuracy of the position determination and for fast executability. With the sequence of the steps, the data volume is quickly reduced, which supports fast executability.

In the sequence position I in step 100, the digital image data are transferred as a grayscale value matrix from the camera 1 to the computer. Step 200 is used to roughly check the validity of the image data on the basis of characteristic values. Further image processing steps may follow, e.g., for preparing the image data or for segmentation into individual code regions. These steps are not shown in detail here. The data volume for a 200×200 camera image 3 is 40,000 pixels and thus 40,000 bytes of grayscale values.

In the sequence position, the symbols (dots) contained in the image are located and entered into a dot matrix, which corresponds to the size of a reading field (here: 15×15 dots), according to their arrangement in the dot code raster. Each symbol is measured with regard to its position and area. The positions are rectified in order to correct distortions by the objective. The areas of the symbols are normalized in order to eliminate the influence of the perspective distortion. On the basis of the normalized area, the symbol type is classified.

This reduces the data volume to 225 dots with meta-information, and thus 9000 bytes. In order also to classify unoccupied raster points or incorrectly depicted symbols as such, a local model of the dot code raster in the camera image is created from the positions of the successfully identified symbols. A search for symbols at all raster points of the model is carried out within the reading field. Due to local occlusion, image errors, or the image field boundary, it is not always possible to identify all symbols. In this case, the corresponding raster positions are classified as “not valid.”

In the sequence position III, fitting lines (beams) are adjusted to the rows and columns of valid dots in the reading field 22.

Each fitting line is described by a line angle in the image field of the camera 1 and a point of intersection with the X or Y axis of the image field coordinate system. Each reading field 22 provides two bundles of fitting lines, corresponding to the two major axis directions of the code arrangement 2. In this example, each line bundle (bunch) comprises up to 15 straight lines. The position data of 15×15=225 dots are thus reduced to the data of 15+15=30 fitting lines.

In the sequence position IV, the straight lines of each bundle are interpolated by two second-order polynomials: one polynomial describes the line angles, a second polynomial describes the axis intersection points of the straight lines of a line bundle.

The polynomial parameters of the two bundles are represented by 12 real values, which corresponds to a reduction by a factor of 5 in comparison to the straight line representation.

In the sequence position V, an inverse mathematical imaging model is also used to calculate the 6D position of the camera 1 from the polynomial parameters of the two line bundles. In addition, the validity of the position value is estimated by evaluating a plurality of diagnostic results from the individual steps of the program sequence. The 6D camera position and validity are output to the higher-level system in step 800.

### Step 200—Check/Validity Test of the Image Data

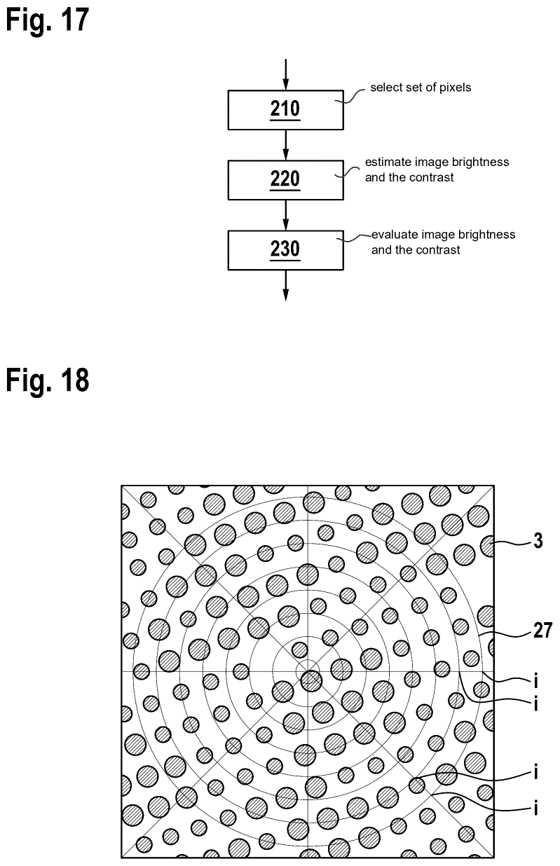

Statistical characteristics are used to check whether an evaluable camera image 3 is present (see flowchart in FIG. 17).

In this example, the image brightness B and the contrast C are estimated and checked for adherence to specified limit values.

Upon deviation from the specified limit values, the further evaluation is aborted and the result is classified as not valid.

In order to save computing time, only a small number of image points is included in the ascertainment of the characteristic numbers, for example the grayscale values at the points of intersection of the straight lines and circles in the intersection point pattern 27 (FIG. 18).

In the lower step 210, a set of pixels is selected, which are determined according to an arbitrary intersection point pattern 27. The pixels at the points of intersection in the intersection point pattern 27 are used. Gᵢ is thus a grayscale value of the pixels at the positions i, i=1 . . . n.

In the lower step 220, the image brightness B and the contrast C are estimated:

$$\begin{matrix}B = mean ( {G}_{i} ) \\ C = \frac{max ( {G}_{i} ) - min ( {G}_{i} )}{max ( {G}_{i} ) + min ( {G}_{i} ) + 1}\end{matrix}$$

In the lower step 230, the image brightness B and contrast C are evaluated with the following conditions:

$$\begin{matrix}( B \leq {B}_{min} ) or ( B \geq {B}_{max} ) \\ ( C < {C}_{min} )\end{matrix}$$

If one of the conditions is fulfilled, the further evaluation is aborted and the result is classified as not valid.

### Detection of the Dot Data/Steps 310 to 350:

The goal is to identify, measure, and classify the dots as base symbols 20 in a reading field 22 of a specified size (here: 15×15 raster points). As a result, a two-dimensional dot matrix 29, or generally base symbol matrix, with the data of the dots is output, wherein the indices of the matrix 29 are assigned to the rows and columns of the code arrangement 2. Characteristic values are ascertained for each dot.

The variable Dot.Typ contains the classification result. If Dot.Typ is positive, the dot was rated as valid:
Dot.Typ=2: large dot; logic «1»
Dot.Typ=1: small dot; logic “0”
Dot.Typ=0: missing dot; parcel symbol 21

If Dot.Typ is negative, the dot could not be unambiguously identified.

In substep 310, a search for a starting basis/starting field (launch pad) 28 is first carried out in the image region and/or in the reading field 22 of the camera image 3 with the dot code of the code arrangement 2. The starting basis/starting field is understood here to mean a field of, e.g., 3×3 neighboring dots of type 1 or 2.

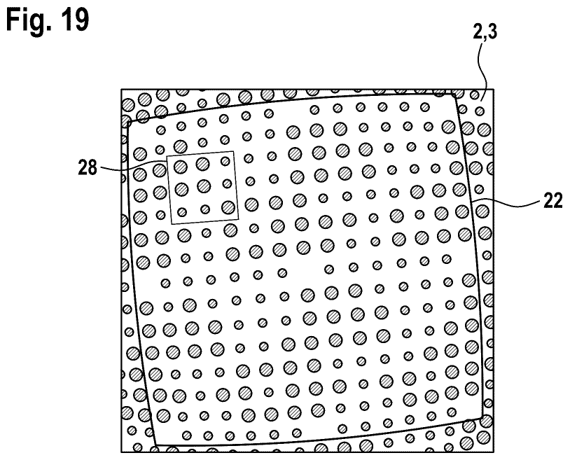

FIG. 19 shows, by way of example, a camera image 3 with an identified starting basis 28 and the reading field 22, in which a search for the dots as base symbols 20 is carried out starting from the starting basis 28.

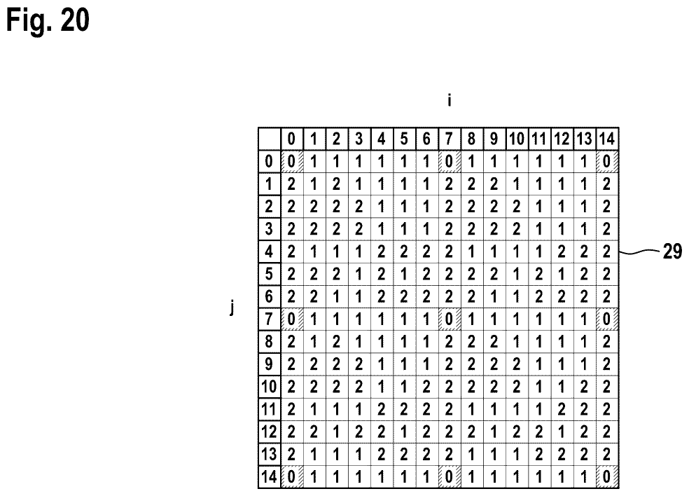

In substep 320, the starting basis 28 is used to construct a local model of the point grid in the vicinity of the starting basis 28. A search for further dots is carried out at the neighboring grid points predicted by the model; if successful, the further dots are measured precisely and entered as valid dots into the dot matrix 29. This process is repeated cyclically so that more and more valid dots around the starting basis 28 are registered until the reading field 22 of 15×15 dots is completely recorded. The search process is robust to local reading errors: If individual dots are not unambiguously identifiable or exceed the image field edge, they are marked as non-valid in the dot matrix 29 and excluded from further processing. FIG. 20 shows the result of a successfully classified dot matrix 29 on the basis of the camera image 3 in FIG. 19.

In substep 330, the center positions and areas of the dots are measured.

Substep 340 converts the measured positions of all valid dot positions in the reading field 22 into rectified coordinates.

This step is used to compensate for the distortion errors of the wide-angle lens (barrel distortion). After rectification, points that are located on a straight line in the code coordinate system 16 are also located on a straight line in the rectified image in the coordinate system of the image sensor 15. Instead of computer-aided rectification, optical rectification can also be performed with a corresponding objective 9 so that the substep 340 is optional.

On the basis of the measured data, the dots are classified in substep 350. Afterwards, in substep 360, the digital code is read in both spatial directions and converted with the aid of the code table into an integer position specification as well as a coarse direction specification in 90° steps. The determination of the coarse position in the upper step 300 is thus complete.

### Substep 310—Ascertainment of the Starting Basis

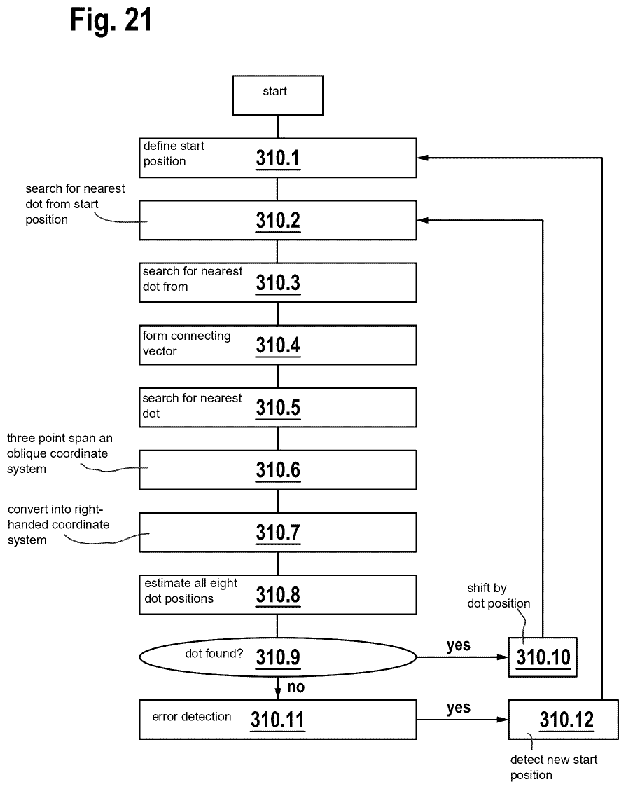

The sequence for determining the starting basis 28 is shown in the flowchart of FIG. 21.

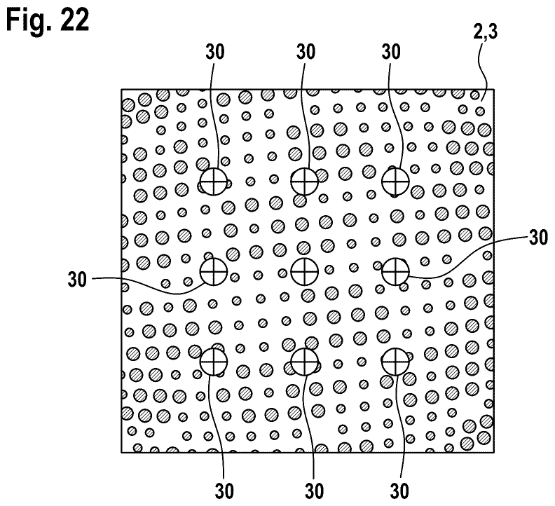

Lower step 310.1: First, a start position 30 for searching for the first dot of the starting basis 28 is defined. FIG. 22 shows multiple predefined start positions 30 in the image field of the camera 1. The search starts at one of these start positions. If the process fails (e.g., due to interference in the image field), a second search is started at the second start position, etc. until the lower step 310.1. can be successfully completed.

If all start positions have been used and no search was successful, lower step 310.1 is aborted with a negative result.

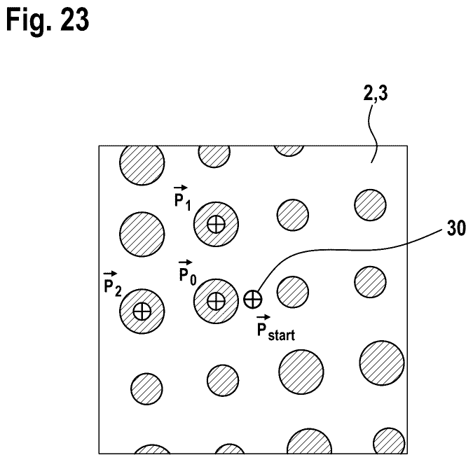

Lower step 310.2: Starting from the start position \vec{P}ₛₜₐᵣₜ/30, a search for the nearest dot is carried out. In FIG. 23, a dot at position \vec{P}₀ is found as the starting base symbol.

Lower step 310.3: Subsequently, starting from \vec{P}₀, a search for the nearest dot is carried out and the nearest point is denoted by P as the first auxiliary starting base symbol.

Lower step 310.4: Afterwards, a connecting vector \vec{E}₁=(\vec{P}₁−\vec{P}₀) is formed.

Lower step 310.5: Starting from \vec{P}₀, a search for the nearest dot is carried out in the direction orthogonal to the connecting vector \vec{E}₁=(\vec{P}₁−\vec{P}₀), and the nearest dot is denoted by \vec{P}₂ as the second auxiliary starting base symbol.

Lower step 310.6: The three points, \vec{P}₀, \vec{P}₁, and \vec{P}₂ span an oblique coordinate system with the axes \vec{E}₁=(\vec{P}₁−\vec{P}₀) and \vec{E}₂=(\vec{P}₂−\vec{P}₀), wherein \vec{P}₀ forms the origin of the coordinate system.

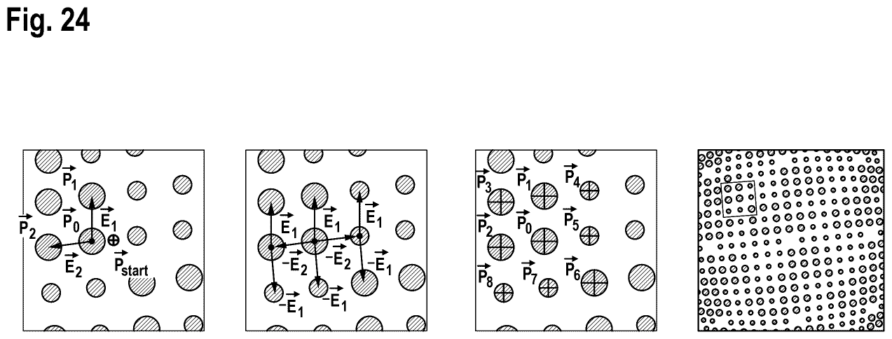

Lower step 310.7: If it is a left-handed coordinate system (condition: (\vec{E}₁×\vec{E}₂)<0), it is converted into a right-handed coordinate system by swapping the axes \vec{E}₁ and \vec{E}₂, see FIG. 24, on the left.

Lower step 310.8: By linear combination of the vectors \vec{E}₁ and \vec{E}₂, all eight dot positions neighboring \vec{P}₀ are estimated (FIG. 24, second from the left) and used as starting field 28 for searching and measuring dots. As a result, a starting basis 28 of 3×3 dots is available (FIG. 24, second from the right, on the right).

Lower step 310.9: If a dot is not found in this process, it is assumed that it is a parcel symbol 21 (missing dot).

In the lower step 310.10, \vec{P}₀ is then shifted by a dot position in the direction opposite to the missing dot and the process is continued by searching for \vec{P}₁ and \vec{P}₂ again. In the second pass, it can be assumed that all 3×3 dots are identified since the next parcel symbol 21 is located at a distance of one parcel 19 (here: 7 dots) and the starting basis is only 3×3 dots.

Subsequently, a lower step 310.11 may be performed for error detection, wherein a new start position 30 is used when an error is detected in a lower step 310.12, and the procedure is repeated starting from the lower step 310.2.

The sequence described above includes the challenge of identifying a dot in the image field of the camera 1 starting from an estimated start position and of measuring its position and area with subpixel accuracy. In order to achieve a short measurement time, this sequence must be carried out very quickly since a total of 225 dots must be identified in a reading field 22.

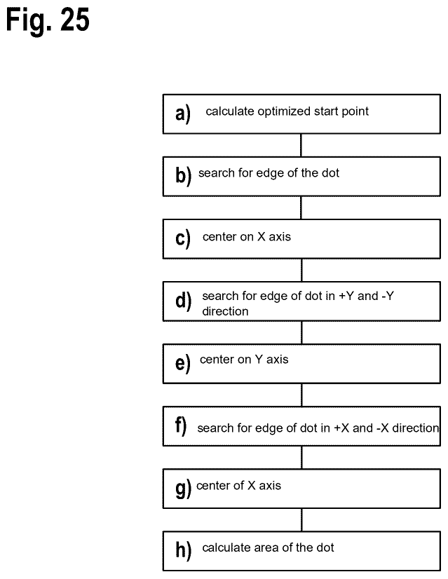

For this purpose, the below-described function Center_Pos is used, which is optimized for the minimum number of pixel accesses. FIG. 25 shows the flowchart.

When the function Center_Pos is called, the estimated center position of the dot \vec{P}₀ is passed. If \vec{P}₀ is outside the search range, the search is aborted and a negative result is returned.

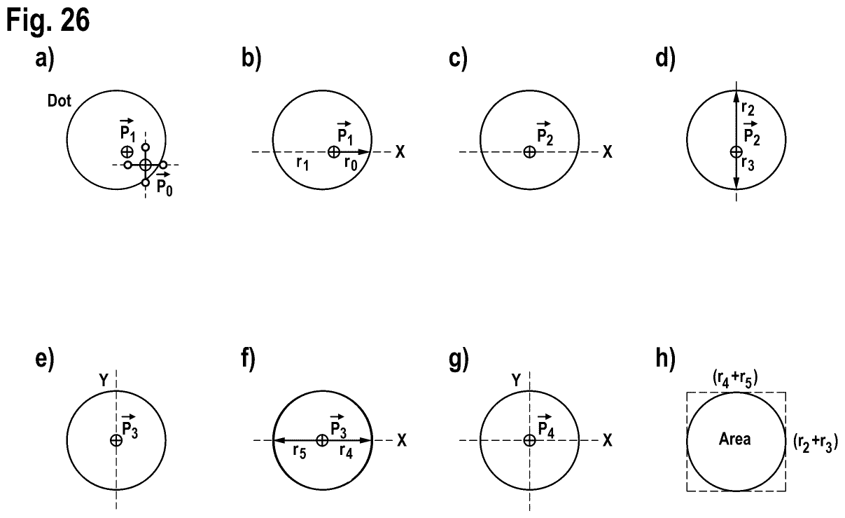

Otherwise, the 8 steps a)-h) are carried out, see also FIG. 26 a-h:
a) Using a grayscale-value-based two-dimensional gradient method, an optimized start point \vec{P}₁ that is closer to the center of the dot is calculated from \vec{P}₀. For the calculation of the gradient, only 4 pixel accesses in the vicinity of the starting point \vec{P}₀ are required.
b) Starting from the optimized point \vec{P}₁, a search for the edge of the dot in the +X and −X directions is carried out using edge detection methods. The distance from \vec{P}₁ to the right edge is r₀, to the left edge r₁.
c) P is centered on the X axis in relation to the left and right edges, resulting in the optimized point \vec{P}₂.
d) Starting from the point \vec{P}₂, a search for the edge of the dot in the +Y and −Y directions is carried out using edge detection methods. The distance from \vec{P}₂ to the upper edge is r₂, to the lower edge r₃.
e) \vec{P}₂ is centered on the Y axis in relation to the upper and lower edges, resulting in the optimized point \vec{P}₃.
f) Starting from the point \vec{P}₃, a search for the edge of the dot in the +X and −X directions is again carried out using edge detection methods. The distance from \vec{P}₃ to the right edge is r₄, to the left edge r₅.
g) \vec{P}₃ is centered on the X axis in relation to the left and right edges. This results in the optimized point \vec{P}₄, which is output as the center position of the dot with subpixel accuracy.
h) The area of the dot is calculated as the area of the circumscribing rectangle, multiplied by the factor π/4 for converting the square area into a circular area or elliptical area:

$$Dot . Area = ( {r}_{2} + {r}_{3} ) \cdot ( {r}_{4} + {r}_{5} ) \cdot \frac{π}{4}$$

The sequence described above also includes the challenge of finding the nearest dot to a start position \vec{P}₀ in the camera image 3. This task can be achieved with the function Nearest dot described below. The function receives the input data
\vec{P}₀ start position
rₘᵢₙ minimum search radius
rₘₐₓ maximum search radius
ND Boolean variable (ND=“neighbor dot”):

If the start position is located within a dot and ND=false, the dot at the position of the start position is output. If ND=true, the dot at the position of the start position is ignored and the nearest neighbor dot is output.

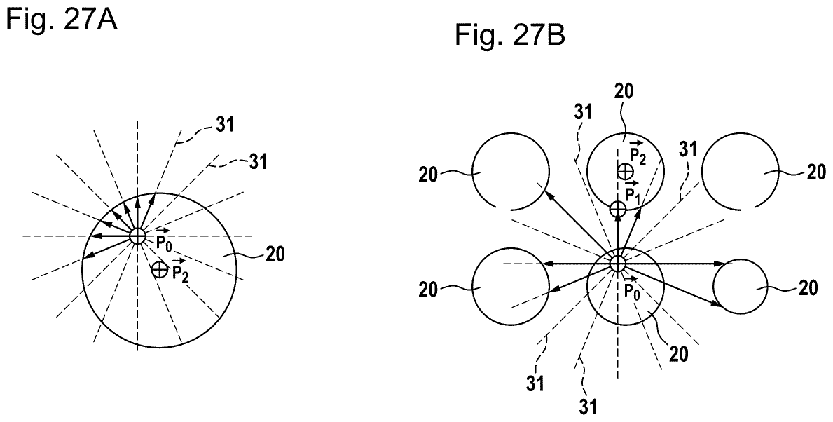

Starting from the start point \vec{P}₀, the function samples the image field along 16 search rays 31 at an angular distance of 22.5° (FIG. 27A, 27B). The radius of all search rays 31 is increased incrementally, starting with the radius rₘᵢₙ, up to the maximum radius rₘₐₓ.

If ND=false (FIG. 27A), a search is carried out both for edges leading into a dot and for edges leading out of a dot. If ND=true (FIG. 27B), a search is carried out for only edges leading into a dot. As soon as an edge has been found, the search is aborted. The edge is located at the position \vec{P}₁; it belongs to the searched-for nearest dot. Starting from \vec{P}₁, the center position and the area of the found dot are determined and output using the function Center Dot.

### Substep 320—Detection of the Dots in the Reading Field

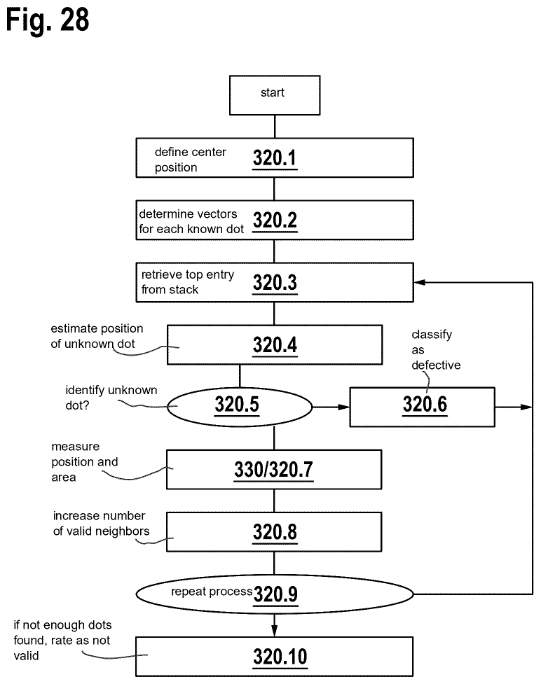

The flowchart in FIG. 28 shows the sequence for detecting all dots in the reading field 22. The previously ascertaining starting basis 28 of, e.g., 3×3 dots is used as input information. In addition, the step 330: Precise measurement of the center position and area of the dots is integrated into the substep 320.

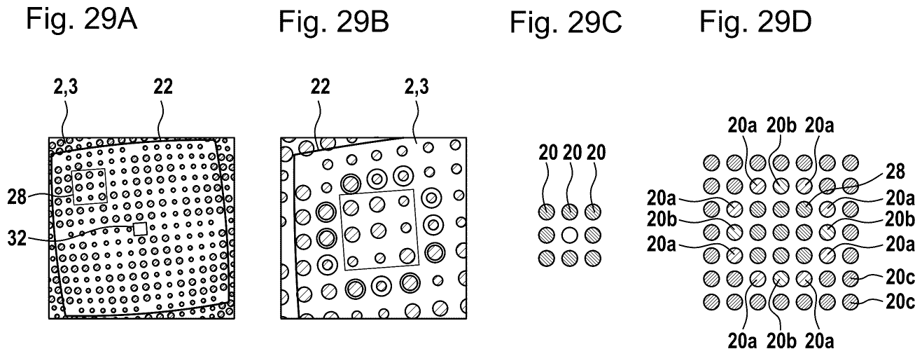

In the first lower step 320.1, the center position 32 of the reading field 22 is defined. This position is selected such that the reading field 22 has as much overlap as possible with the image region in which the code is represented, so that as many valid dots as possible can be detected. Usually, this is the case if the center of the reading field 22 is located at the center of the code region. If the code region occupies the entire image area, as in the present example, the center position 32 of the reading field is placed as close to the image center as possible (see FIG. 29A).

At the beginning of the method, only the 3×3 dots of the starting basis 28 are known. All other dots in reading field 22 are still unknown, i.e., their exact position and area has not yet been measured. The aim of the method is to measure and classify the unknown dots gradually.

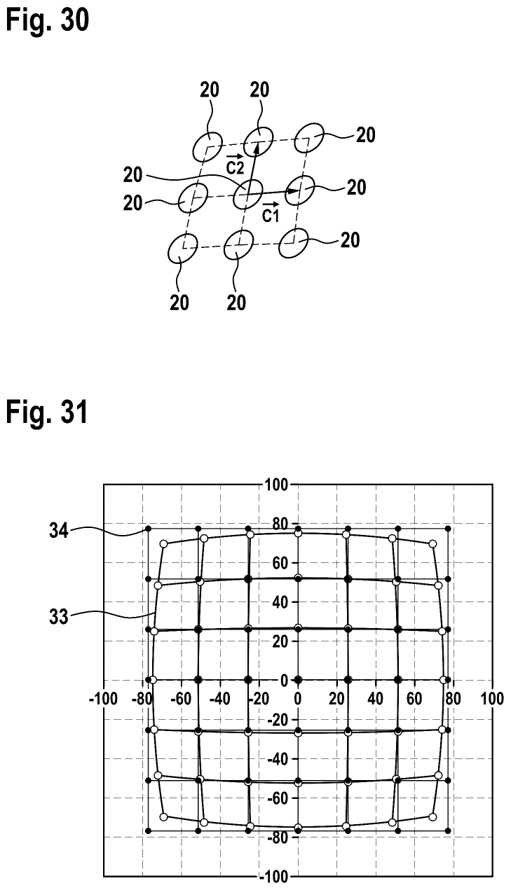

Lower step 320.2: For each known dot, the vectors Dot.\vec{C}₁ and Dot.\vec{C}₂ that point to the nearest neighbor dots in the major axis directions 1 and 2 are determined (FIG. 30). Due to the perspective distortion, they span an oblique coordinate system.

By linear combination of the vectors Dot.\vec{C}₁ and Dot.\vec{C}₂, the raster positions of the unknown neighboring dots can be estimated. The position estimate for an unknown dot can be improved by extrapolating and averaging the estimated values of multiple valid neighbors.

The more valid neighbors an unknown dot has, the better its position can be estimated. In order to increase the reliability of the reading process, only unknown dots having at least two valid neighbors are examined.

For each unknown dot, the number of valid neighbors is counted.

This number may be between 0 and 8, see FIG. 29C): The center dot position has 8 neighboring positions (dark).

At the start of the search, only the 3×3 dots of the starting basis are valid. The individual unknown dots with 2 or more valid neighbors are shown amplified in FIG. 29B. FIG. 29D schematically shows the unknown dots with 2 valid neighbors 20 a and with 3 valid neighbors as 20 b. All other unknown dots (20c) do not yet have any valid neighbors.

The algorithm is based on a stack, wherein all unknown dots with at least 2 valid neighbors are entered entered into the stack in the lower step 320.3.

The stack is processed in a loop:
Lower step 320.3: The top entry is retrieved as an unknown dot from the stack and processed in the following steps.
Lower step 320.4: The position of the unknown dot is estimated by averaging the extrapolated positions of all valid neighbors. If the unknown dot is outside the expected reading field 22, it is not further processed. If the unknown dot is within the expected reading field 22, it is identified and measured at the estimated position with the function Center_Pos.
Lower step 320.5: If the unknown dot cannot be identified, it is classified as defective (lower step 320.6) and the next unknown dot is retrieved from the stack.
Step 330/lower step 320.7: If the dot was identified, its position and area is measured with the function Center_Pos and it is entered as a valid new dot into the dot matrix 29. The vectors Dot.\vec{C}₁ and Dot.\vec{C}₂ for this dot are also calculated and entered.
Lower step 320.8: For all 8 neighbors of the new valid dot, the number of valid neighbors is increased by 1. If an unknown dot has two or more valid neighbors as a result, it is placed on the stack for measurement.
Lower step 320.9: This process is repeated until the stack is empty. Then, all dots of the reading field have been processed.
Lower step 320.10: If not enough dots to determine the position have been found, the reading process is rated as not valid.

### Substep 340—Rectification

Projection with the wide-angle lens can result in a barrel distortion of the image field. Lines of dots that are located on a straight line in the code plane of the code arrangement 2 may be located on a curved line in the camera image 3.

This curvature can be eliminated by a mathematical method, the rectification. For computing time reasons, rectification is only applied to the center positions 32 of the dots, not to all image points of the input image. FIG. 31 shows, by way of example, an non-rectified raster (33) and a rectified raster (34).

The center of the distortion \vec{IC} is located at the point of intersection of the optical axis 5 with the camera chip of the image sensor 12; if the camera 1 is mounted perfectly, this is usually the center of the camera chip. Otherwise, the center is determined by a single calibration process of the camera 1. With a second-order polynomial, a position \vec{P} in the image field of the camera 3 is converted into the 90 ectifyed position \vec{R}:

$$\vec{R} = ( {p}_{0} + {p}_{1} D + {p}_{2} {D}^{2} ) \cdot \vec{D} + \vec{IC}$$

with
\vec{D}=(\vec{P}−\vec{IC}) position in relation to the center of distortion
D=|\vec{D}| distance to the center of distortion

The distortion only changes the length of the vector \vec{D}, not its direction. The polynomial parameters p₀, p₁, p₂ are specific to the objective 9 and are adapted thereto in a calibration process. Alternatively, a distortion-free objective 9 can be used.

### Substep 350—Classification of the Dots

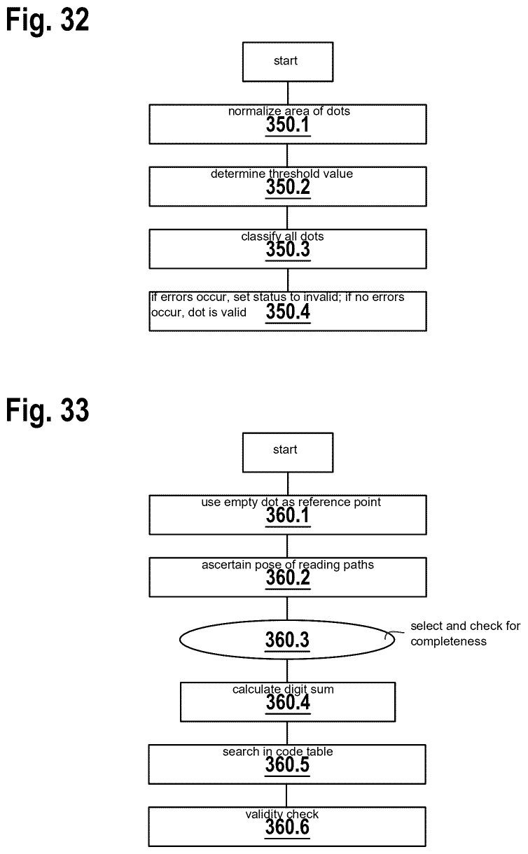

The small and large dots symbolize the values “0” and “1” of the binary number system. The classification of the dots is carried out on the basis of a threshold value for the normalized area of the dots. The sequence is shown in the flowchart of FIG. 32.

The perspective distortion has a strong influence on the area of the dots in the image field. For example, dots that are further away are imaged smaller, circular dots on an inclined plane are imaged as ellipses.

Lower step 350.1: In order to compensate for these effects, the area of the dots is normalized with respect to the area of their dot cell. The term “dot cell” is understood to mean the parallelogram that the vectors Dot.C1 and Dot.C2 span at the position of the dot, i.e., the distance vectors from the dot to the dots neighboring in the major axis directions 1 and 2.

FIG. 30 shows a perspectively distorted dot in a distorted raster that is spanned locally by the vectors Dot.C1 and Dot.C2. The area of the cell is |Dot.C1×Dot.C2|.

The normalized area of the dot is calculated as follows:

Dot.Area_{scaled}=Dot.Area/|Dot.\vec{C}₁×Dot.\vec{C}₂|

Lower step 350.2: The threshold value is determined by statistical methods from the normalized areas Dot.Area_{scaled} of all dots.

Lower step 350.3: Subsequently, all dots are classified:
Missing dot: type 0
Normalized area less than threshold value: type 1; otherwise: type 2.

Lower step 350.4: If errors occur, the status is set to invalid; if no errors occur, the dot is valid.

### Substep 360—Reading of the Code

After the classification of the dots, the dot matrix 29 contains all the information to ascertain the 6D position.

The dot matrix 29 contains the following information:

| | | Data are provided |
|---|---|---|
| | | by the following |
| Dot data | Description | steps: |
| Dot_{i, j}.\vec{P} | Accurate dot centers | Substep 310 and |
| | in the original | 320, function: |
| | image coordinates | Center_Pos: |
| | | subpixel-accurate |
| | | detection of the |
| | | dot center |
| Dot_{i, j}.\vec{R} | Dot centers in the | Substep 340, |
| | rectified image | function: |
| | coordinates | Rectify: |
| | | rectification of |
| | | Dot_{i, j}.\vec{P} |
| Dot_{i, j}.\vec{C1} Dot_{i, j}.\vec{C2} | Local distance | Substep 310 and |
| | vector between | 320, calculated |
| | neighboring dots in | from the dot |
| | the first and the | centers in the |
| | second raster | original image |
| | direction. | coordinates Dot_{i, j}.\vec{P} |
| Dot_{i, j}.Area | Dot area in the | Substep 310 and |
| | original image | 320, Center_Pos: |
| | coordinates [pixels] | dot area |
| | | detection |
| Dot_{i, j}.Typ | Classified dot type | Substep 340, dot |
| | | classification on |
| | | the basis of the |
| | | dot area |
| Dot_{i, j}.VN | Number of the valid | Substep 310 and |
| | neighbor dots | 320, counting the |
| | | valid neighbors |

The flowchart in this respect is shown in FIG. 33. The digital coarse position in the X and Y directions is ascertained by reading the X and Y bit strings in the dot matrix.

Lower step 360.1: The parcel symbol 21 “empty dot” (type 0) is used as a reference point to identify the pose of the bit strings in the dot matrix 29. If multiple entries with type 0 are contained, they can be cross-validated since the “empty dot” is regularly repeated in the parcel raster (here: 7×7 dots).

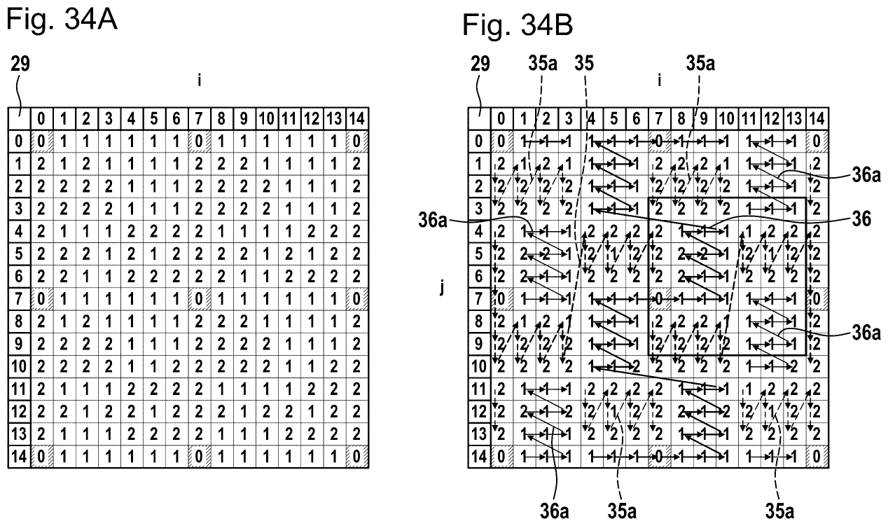

Lower step 360.2: Starting from the parcel symbol 21, the pose of the reading paths for the codes in the two axes of the code plane is ascertained. It is initially unknown which of the sequences are assigned to the X axis and which are assigned to the Y axis and in which direction (forward or backward) the code is read. The codes are read along the reading path and are saved as Code_0 and Code_1. FIG. 34A) shows, by way of example, the dot types entered in the dot matrix. The parcel symbol (type 0) is gray-shaded. In FIG. 34B), the reading path for the two axes is additionally shown. The reading paths of the two axes are rotated by 90° to each other, with the parcel symbol 21 forming the center of rotation.

Since the reading field (15×15 dots) is significantly larger than a parcel (7×7), the code may be read redundantly: A copy of Code_0 is in the neighboring parcels (35a) in the j direction, and a copy of Code_1 is in the neighboring parcels (36a) in the i direction.

There is also redundancy in the length of the readable code. A code length of 24 bits in each direction, i.e., the content of a 7×7 parcel, is sufficient to determine the position. However, the larger reading field with 15×15 dots provides 51 or 54 bits in each direction. The redundant information is used to detect and correct individual, incorrectly read bits in Code_0 and Code_1.

In this example, the following codes are read:
Code_0:
111, 111, 011, 111, 011, 111, 111, 111, 111, 111, 111, 111, 011, 011, 111, 11 1, 111, 111
Code_1:
000, 000, 000, 101, 000, 001, 000, 000, 000, 000, 100, 110, 000, 000, 000, 00 0, 000, 000

Lower step 360.3: From Code_0, any portion with t=24 consecutive bits is selected and checked for completeness.

Lower step 360.4: The digit sum of Code_0 is subsequently calculated. If it is less than t/2=12, Code_0 is the X code and Code_1 is the Y code. If it is greater than t/2, Code_0 is the Y code and Code_1 is the X code. The Y code is inverted. The X code remains unchanged.

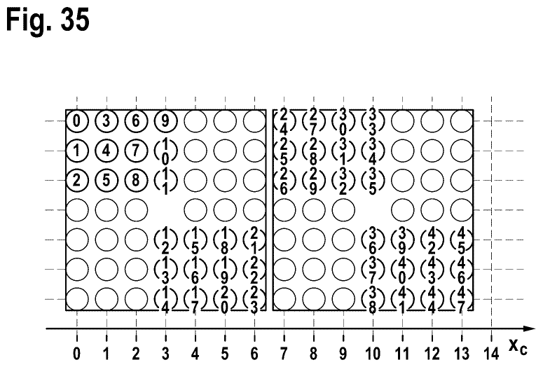

Lower step 360.5: Afterwards, a search for Code_0 and Code_1 in the code table is carried out by means of a fault-tolerant string search. The bit position with the best match is output as the search result; if the deviation is too large, the search result is rated as not valid. In order to transform Code_0 and Code_1 into integer position coordinates (X, Y), the bit position of the codes is converted into a spatial position according to the code structure, as is schematically shown in FIG. 35 by way of example:
Any any portion with t=24 consecutive bits is selected and checked for completeness:
000100000000001010100000

A search for this portion in the code table in the forward direction is carried out and the portion is found at the bit position 37 according to the underlining:
0101010100000000100000000001000100000000100000000001010100000000 1000000001000101000000001 . . .
   Each X dot is assigned a bit position within the code table.
   The bit position corresponds to the starting point in the reading order within a parcel.
   Each Y dot is assigned a bit position within the code table.

### 360.6 Validity Check

According to FIG. 35, this corresponds to the dot position Xc=10=Pos₀. The Yc value for Pos, is ascertained analogously. For both codes, the reading direction (Dir_0 and Dir_1) is also ascertained by searching for the codes in both directions in the code table: 0=found in the forward direction, 1=found in the backward direction. According to the table below, the coarse orientation of the reading window 22 in steps of 90° is determined from the reading directions of Code_0 and Code_1.

Dir₀

| | | 0 | 1 |
|---|---|---|---|
| Dir₁ | 0 | 0° | 270° |
| | 1 | 90° | 180° |

As a result of substep 360, the integer coarse position (r_{X,int}, r_{Y,int}) and the orientation of the reading window 22 is available.

### Step 400—Ascertainment of the Beam Data

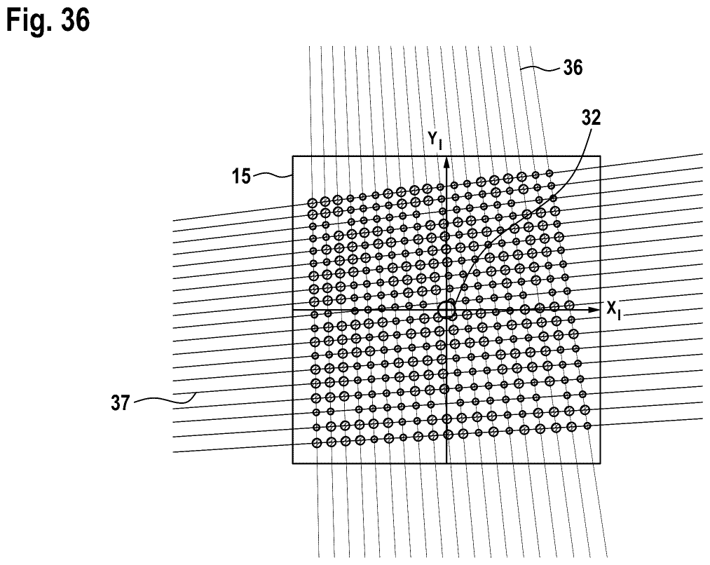

In order to ascertain the fine position, the rectified position data of the valid dots in the dot matrix 29 are evaluated. FIG. 36 shows, by way of example, the dots of a reading field in the camera image after the rectification.

### Step 410: Adjustment of Fitting Lines

For this purpose, fitting lines (beams) are adjusted to the rows and columns of valid dots in the reading field 22. The fitting line is calculated from the position data of the valid dots in the particular row or column by means of conventional mathematical error minimization methods. Non-valid dots are excluded from the process.

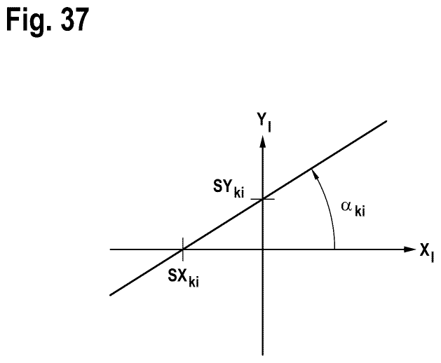

Each fitting line i of the bunch k=0.1 is described by the following parameters (FIG. 37):
SXₖᵢ point of intersection with the X-axis
SYₖᵢ point of intersection with the Y-axis
αₖᵢ angle of the straight line i in the image field

The fitting lines adjusted to the dot rows form a first line bundle (bunch₀) 36, wherein the straight lines are parallel to the Y_{C}-axis. The straight lines of the dot columns form a second line bundle (bunch₁) 37, wherein the straight lines are parallel to the X_{C}-axis. The position data of 15×15=225 dots are thus reduced to the data of 15+15=30 fitting lines.

The interpolation also has the effect that averaging over the dot positions on each straight line is carried out so that the fitting lines are robust to individual fluctuations of the individual dot positions. This increases the stability and accuracy of the 6D position value.

In FIG. 36, the fitting lines for a reading field with 15×15 dots are shown, the straight lines of bunch₀ as 36 and the lines of bunch₁ as 37.

### Step 420—Ascertainment of the Bunch Data

In this step, the three line parameters SXₖᵢ, SYₖᵢ, αₖᵢ of each bundle of fitting lines 36, 37 are interpolated with a second-order polynomial. The interpolation method only takes into account valid straight lines. Non-valid straight lines, for whose interpolation too few valid dots are available, are excluded from the bunch interpolation. For this purpose, a weighted interpolation based on the minimization of squared errors is performed using conventional mathematical methods.

Valid straight lines are weighted 1.0, while non-valid straight lines are weighted 0.0 and thus excluded.

Ansatz for the interpolation function:

$$\begin{matrix}S {X}_{k} ( i ) = p s {x}_{k 0} + i \cdot p {sx}_{k 1} + {i}^{2} \cdot p {sx}_{k 2} \\ {SY}_{k} ( i ) = p s {y}_{k 0} + i \cdot p {sy}_{k 1} + {i}^{2} \cdot p {sy}_{k 2} \\ {α}_{k} ( i ) = p {α}_{k 0} + i \cdot p {α}_{k 1} + {i}^{2} \cdot p {α}_{k 2}\end{matrix}$$

Here, i is the consecutive number of the straight lines (line index) in the particular line bundle.

General ansatz for the interpolation of the line parameters:

$${P}_{k} ( i ) = {p}_{k 0} + i \cdot {p}_{k 1} + {i}^{2} \cdot {p}_{k 2} ; \qquad with {P}_{k} ( i ) = S {X}_{k} ( i ) , \qquad {SY}_{k} ( i ) or {α}_{k} ( i )$$

For a mathematically unambiguous description of a straight line, it is sufficient to specify only one of the two axis intersection points SXₖᵢ or SYₖᵢ together with the line angle αₖᵢ.

Ideally, the point of intersection with the axis that is as perpendicular as possible to the straight line is specified: For shallow straight lines, the point of intersection with the Y axis is preferably specified; for steep straight lines, the point of intersection with the X axis is preferably specified.

The following method is therefore used:
In bundle 1, a straight reference line that is close to the center 32 of the reading field 22 is selected.
If the angle of the straight reference line is in the range

$$\begin{matrix}[ \frac{- 1}{4} π , & \frac{1}{4} π ] or\end{matrix} \begin{matrix}[ \frac{3}{4} π , & \frac{5}{4} π ]\end{matrix}$$

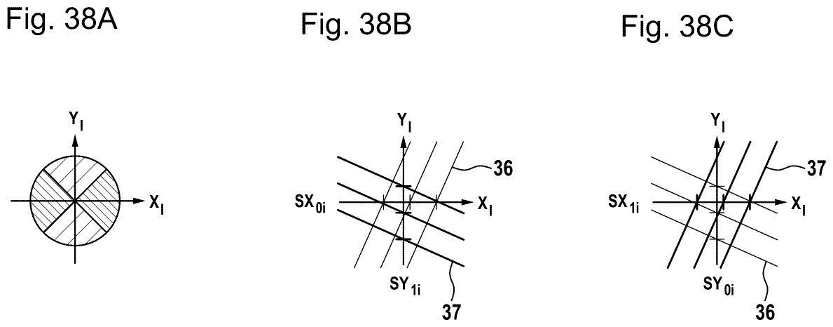

(sectors on the X_{I}-axis in FIG. 38A), it is a shallow straight line. In this case, the point of intersection SX_{Oi} with the X-axis is specified for all straight lines in bundle 0 (36), and the point of intersection SY₁ᵢ with the Y-axis is specified for all straight lines in bundle 1 (37) (FIG. 38B). As a flag, rot_status is set to 0.
If the angle of the straight reference line is outside the mentioned range (sectors on the Y-axis in FIG. 38A), it is a steep straight line. In this case, the point of intersection SY_{Oi} with the Y-axis is specified for all straight lines in bundle 0 (36), and the point of intersection SX₁ᵢ with the X-axis is specified for all straight lines in bundle 1 (37) (FIG. 38C). As a flag, rot_status is set to 1.

This step further reduces the amount of data: A bundle of straight lines is described by only 6 parameters, three parameters for αₖᵢ and three parameters for one of the axis intersection points, SXₖᵢ or SYₖᵢ. For two bundles, there are 12 parameters as well as the rot_status flag.

Two bundles 36, 37 are thus always described by 12 parameters and the Boolean variable rot_status, regardless of the number of straight lines or the size of the measurement field. The next step calculates the 6D position from these parameters.

The interpolation also has the effect that averaging over the straight lines of each bundle and thus over all dots is carried out so that the interpolated values are robust to individual fluctuations of individual straight lines or dots. This increases the stability and accuracy of the 6D position value.

### Step 6—Calculation of the 6D Camera Position

The 6 coordinates of the camera position are calculated from the 12 interpolation parameters of the line bundles (Table 9.1), in the following order:
Substep 500: position r_{X} and r_{Y}.
Substep 710: calculation of characteristic values of the distorted raster
Substep 600: camera angle φ_{Z}
Substep 700: position r_{Z}
Substep 700: camera angles φ_{X} and φ_{Y}
Substep 700: iterative algorithm for solving the system of equations for φ_{X}, φ_{Y}, and r_{Z}

The calculation comprises the derivation of characteristic values that describe the measured raster at the position of the optical axis 5. These characteristic values are associated with the 6D camera position via a system of equations resulting from the imaging model and the laws of ray optics.

The camera position is determined by solving the system of equations.

In addition, the validity of the position values is estimated by evaluating a plurality of diagnostic results from the individual steps of the program sequence.

Substep 500—Calculation of the Camera Position r_{X} and r_{Y}

The camera position in X and Y is calculated as the sum of the integer coarse position (r_{X,int}, r_{Y,int}) and a real fraction [0 . . . 1] (fine position), multiplied by the dot raster spacing:

$$\begin{matrix}{r}_{X} = ( {r}_{X , i n t} + {r}_{X , fract} ) \cdot {c}_{g r i d} & ; unit : & [ m ] \\ {r}_{Y} = ( {r}_{Y , i n t} + {r}_{Y , fract} ) \cdot {c}_{g r i d} & ; unit : & [ m ]\end{matrix}$$

with (r_{X,int}, r_{Y,int}): integer position of the reading field in [dots], as ascertained in step 300
(r_{X,fract}, r_{Y,fract}): real fraction of the reading field position in [dots]
c_{grid}: dot raster spacing in [m/dot].

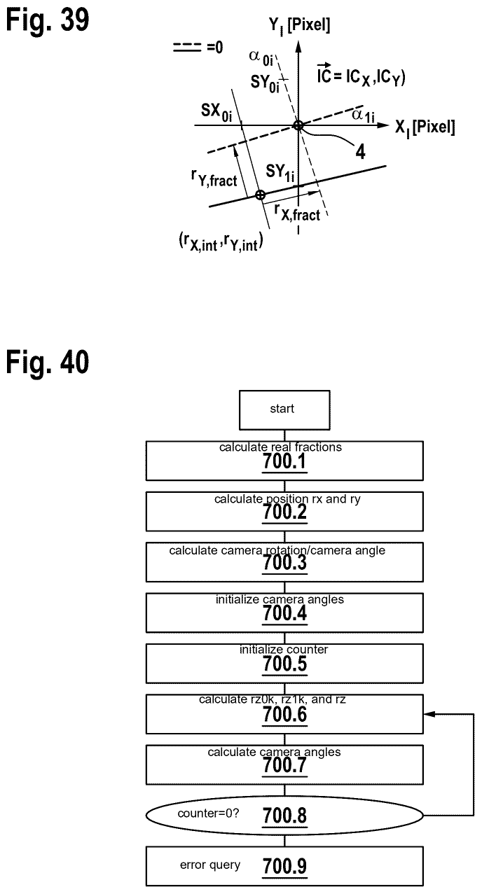

The reference point for measuring the camera position is the point of intersection 4 of the optical axis 5 with the code arrangement 2; in the camera image 3, it is the point of intersection of the optical axis 5 with the image sensor 12 (FIG. 2, point (4) or image of the point of intersection 4/image center 4 in FIG. 39). This image center IC (4) is determined by the pose of the objective 9 in relation to the camera chip but does not have to be identical to the center of the camera chip. It is ascertained in a calibration process and stored as a constant two-dimensional vector (IC_{X}, IC_{Y}) in the program. The fractions r_{X,fract} and r_{Y,fract} are calculated as the point of intersection of the interpolated straight line with the image center 4. For the two ray bundles k=0 and k=1 (36, 37), the interpolation equation applies to the axis intersection point:
Sₖ(i)=psₖ₀+i·psₖ₁+i²·psₖ₂; with Sₖ(i)=SXₖ(i) or SYₖ(i), depending on rot_status.

In FIG. 39, the center straight lines for both line bundles k=0 and k=1 are shown.

The following applies:

$$\begin{matrix}for rot\_status = 0 : ( \begin{matrix}{S}_{0} ( {r}_{X , fract} ) \\ {S}_{1} ( {r}_{Y , fract} )\end{matrix} ) = ( \begin{matrix}{IC}_{X} \\ {IC}_{Y}\end{matrix} ) \\ for rot\_status = 1 : ( \begin{matrix}{S}_{0} ( {r}_{X , fract} ) \\ {S}_{1} ( {r}_{Y , fract} )\end{matrix} ) = ( \begin{matrix}{IC}_{Y} \\ {IC}_{X}\end{matrix} )\end{matrix}$$

By suitably selecting the interpolation parameters (i,j), the axis intersection point for both center straight lines is shifted to the image center \vec{IC}. This is fulfilled by the equations

$$\begin{matrix}for line bundle 0 : {r}_{X , fract}^{2} + {r}_{X , fract} \cdot \frac{p {s}_{01}}{p {s}_{02}} + \frac{( p {s}_{00} - {T}_{X} )}{p {s}_{02}} = 0 \\ for line bundle 1 : {r}_{Y , fract}^{2} + {r}_{Y , fract} \cdot \frac{p {s}_{11}}{p {s}_{12}} + \frac{( p {s}_{10} - {T}_{Y} )}{p {s}_{12}} = 0 \\ with ( {T}_{X} , {T}_{Y} ) = \{ \begin{matrix}( {IC}_{X} , {IC}_{Y} ) & for rot\_status = 0 \\ ( {IC}_{Y} , {IC}_{X} ) & for rot\_status = 1\end{matrix}\end{matrix}$$

The solution of the equations leads to the desired fractions of the line indices r_{X,fract} and r_{Y,fract}:

$$\begin{matrix}{r}_{X , fract} = \frac{- 1}{2 \cdot p {s}_{02}} ( sign ( p {s}_{01} ) \cdot \sqrt{p {s}_{01}^{2} - 4 \cdot p {s}_{02} \cdot ( p {s}_{00} - {T}_{X} )} - p {s}_{01} ) \\ {r}_{Y , fract} = \frac{- 1}{2 \cdot p {s}_{12}} ( sign ( p {s}_{11} ) \cdot \sqrt{p {s}_{11}^{2} - 4 \cdot p {s}_{12} \cdot ( p {s}_{10} - {T}_{Y} )} - p {s}_{11} )\end{matrix}$$

### Substep 710—Calculation of Characteristic Values of the Distorted Raster

Further characteristic values, which characterize the distorted raster, are obtained from the interpolation equations. The fine positions r_{X,fract} and r_{Y,fract} are inserted into the interpolation equations in order to obtain the characteristic values in the image center. The characteristic values are needed to determine the position in the dimensions r_{Z}, φ_{X}, φ_{Y}, and φ_{Z}.

A) Raster Spacing of the Axis Intersection Points of the Straight Lines for Both Line Bundles: G_{C0}, g_{C1}.

The raster spacing is determined by differentiating the interpolation function for the axis intersection point Sₖ(i) with respect to the dimensionless line index i at the position of the image center:

$$\begin{matrix}for {bunch}_{k} : {g}_{C k} = {p}_{g r i d} \cdot \frac{\partial {S}_{k} ( i )}{{\partial }_{i}} {\vert}_{i = {r}_{f r a c t}} = {p}_{g r i d} \cdot ( p {s}_{k 1} + 2 \cdot {r}_{fract} \cdot p {s}_{k 2} ) \\ {r}_{fract} = \{ \begin{matrix}{r}_{X , fract} for k = 0 \\ {r}_{Y , fract} for k = 1\end{matrix}\end{matrix}$$

b) Line Angle in the Image Center: α_{C0}, α_{C1} (See FIG. 37), Results from the Interpolation Function for the Line Angle:

$$for {bunch}_{k} : {α}_{Ck} = {α}_{k} ( {r}_{fract} ) = {α}_{k 0} + {r}_{fract} \cdot {α}_{k 1} + {r}_{fract}^{2} \cdot {α}_{k 2}^{2}$$

c) Angular Divergence of the Line Bundles in the Image Center: dα_{C0}, dαC₁

This means the angular difference between neighboring straight lines close to the image center. It results from the differentiation of the interpolation function for the line angle with respect to the dimensionless line index i at the position of the image center:

$$for {bunch}_{k} : d {α}_{Ck} = \frac{\partial {α}_{k} ( i )}{{\partial }_{i}} {\vert}_{i = {r}_{fract}} = {α}_{k 1} + 2 \cdot {r}_{fract} \cdot {α}_{k 2}$$

### Substep 600—Calculation of the Camera Angle φ_{Z}

The line angle φ_{Z} is ascertained from the imaging equation derived in 2.4.2:

$$( \begin{matrix}{B}_{X} \\ {B}_{Y}\end{matrix} ) = \frac{b}{( {R}_{31} {x}_{0} + {R}_{32} {y}_{0} + {r}_{Z} )} \cdot ( \begin{matrix}{R}_{11} {x}_{0} + {R}_{12} {y}_{0} \\ {R}_{21} {x}_{0} + {R}_{22} {y}_{0}\end{matrix} ) ;$$

with r_{Z}=z₀−b: distance between code plane and optical center

Differentiating the image coordinates B_{X} and B_{Y} with respect to the code raster coordinate x₀ results in

$$\frac{\partial {B}_{X}}{\partial {x}_{0}} = b \frac{( {R}_{11} {R}_{32} - {R}_{12} {R}_{31} ) {y}_{0} + {R}_{11} {r}_{Z}}{{( {R}_{31} x + {R}_{32} {y}_{0} + {r}_{Z} )}^{2}} ; \\ \frac{\partial {B}_{Y}}{\partial {x}_{0}} = b \frac{( {R}_{21} {R}_{32} - {R}_{22} {R}_{31} ) {y}_{0} + {R}_{21} {r}_{Z}}{{( {R}_{31} {x}_{0} + {R}_{32} {y}_{0} + {r}_{Z} )}^{2}}$$

The slope of a straight line of the line bundle bunch in the camera image is

$${m}_{1} = \frac{\partial {B}_{Y} / \partial {x}_{0}}{\partial {B}_{X} / \partial {x}_{0}} = \frac{( {R}_{21} {R}_{32} - {R}_{22} {R}_{31} ) {y}_{0} + {R}_{21} {r}_{Z}}{( {R}_{11} {R}_{32} - {R}_{12} {R}_{31} ) {y}_{0} + {R}_{11} {r}_{Z}} = \frac{\begin{matrix}( sin {φ}_{X} sin {φ}_{Z} - cos {φ}_{X} sin {φ}_{Y} cos {φ}_{Z} ) \cdot \\ {y}_{0} - cos {φ}_{Y} sin {φ}_{Z} \cdot {r}_{Z}\end{matrix}}{\begin{matrix}( - sin {φ}_{X} cos {φ}_{Z} - cos {φ}_{X} sin {φ}_{Y} sin {φ}_{Z} ) \cdot \\ {y}_{0} + cos {φ}_{Y} cos {φ}_{Z} \cdot {r}_{Z}\end{matrix}}$$

When considering the slope in the center at y₀=0, the result is m₁|_{y}_{ₒ}₌₀=−tan(φ_{Z}).

m₁|_{y}_{ₒ}₌₀ is the slope of the straight lines of bunch in the image center. It corresponds to the characteristic value α_{C1} from 6.2 b), i.e., m₁|_{y}_{ₒ}₌₀=tan(α_{C1}).

This leads to the equation for the camera angle σ_{Z}: φ_{Z}=α_{C1}

### Substep 700—Calculation of the Camera Position r_{Z}

The camera position r_{Z} is ascertained from the raster spacing of the axis intersection points get for both line bundles bunchᵢ.

Since there are two line bundles in each image, two r_{Z} positions can basically be ascertained. In cases where rot_status=k, four values r_{Zik} with (i,k=0.1) result. The imaging equation for FIG. 9 applies:

$$( \begin{matrix}{B}_{X} \\ {B}_{Y}\end{matrix} ) = \frac{b}{( {R}_{31} {x}_{0} + {R}_{32} {y}_{0} + {r}_{Z} )} \cdot ( \begin{matrix}{R}_{11} {x}_{0} + {R}_{12} {y}_{0} \\ {R}_{21} {x}_{0} + {R}_{22} {y}_{0}\end{matrix} ) ;$$

with r_{Z}=b−z₀: distance between code plane and optical center

By way of example, the value r_{Z00} is ascertained from the measured raster distance g_{C0} of the axis intersection points on the Bx axis for rot_status=0.

On the By axis, the following applies: B_{Y}=0 and, from the imaging equation, it follows that

$${R}_{21} {x}_{0} + {R}_{22} {y}_{0} = 0 ⇒ {y}_{0} = - \frac{{R}_{21}}{{R}_{22}} {x}_{0}$$

Inserting this term into the equation for B_{X} results in

$${B}_{X} = \frac{b \cdot ( {R}_{11} {R}_{22} - {R}_{12} {R}_{21} ) {x}_{0}}{( {R}_{22} {R}_{31} - {R}_{21} {R}_{32} ) {x}_{0} + {R}_{22} {r}_{Z 00}}$$

The raster spacing g_{C0} corresponds to the derivative

$$\frac{\partial {B}_{X}}{\partial {x}_{0}^{′}} at {x}_{0}^{′} = 0 ; with {x}_{0}^{′} = \frac{{x}_{0}}{{c}_{grid}}$$

line index in [dots]

It follows therefrom that

$$\frac{\partial {B}_{X}}{\partial {x}_{0}^{′}} = \frac{\partial {B}_{X}}{\partial {x}_{0}} \cdot {c}_{grid} = \frac{b \cdot {c}_{grid} \cdot ( {R}_{11} {R}_{22} - {R}_{12} {R}_{21} ) {R}_{22} \cdot {r}_{Z 00}}{{( ( {R}_{22} {R}_{31} - {R}_{21} {R}_{32} ) {x}_{0} + {R}_{22} {r}_{Z 00} )}^{2}}$$

At x₀=0, the result is

$${g}_{C 0} = \frac{\partial {B}_{X}}{\partial {x}_{0}^{′}} {\vert}_{{x}_{0} = 0} = \frac{b \cdot {c}_{grid} \cdot ( {R}_{11} {R}_{22} - {R}_{12} {R}_{21} )}{{R}_{22} {r}_{Z 00}} ,$$

and solved for r_{Z00}:

$${r}_{Z 00} = \frac{b \cdot {c}_{grid} \cdot ( {R}_{11} {R}_{22} - {R}_{12} {R}_{21} )}{{g}_{C 0} \cdot {R}_{22}}$$

Inserting the matrix elements Rᵢⱼ results in the equation for r_{Z00}:

$${r}_{Z 00} = \frac{b \cdot {c}_{grid} \cdot cos {φ}_{Y}}{{g}_{C 0} \cdot ( cos {φ}_{Z} - tan {φ}_{X} sin {φ}_{Y} sin {φ}_{Z} )}$$

The position r_{Z01} for rot_status=1 is calculated in the same way, ansatz:

$${g}_{C 0} = \frac{\partial {B}_{Y}}{\partial {x}_{0}^{′}} {\vert}_{{x}_{0} = 0}$$

The positions r_{Z1k} are derived from g_{C1}, ansatz for r_{Z10}:

$${g}_{C 1} = \frac{\partial {B}_{Y}}{\partial {y}_{0}^{′}} {\vert}_{{y}_{0} = 0} ; for {r}_{Z 11} : {g}_{C 1} = \frac{\partial {B}_{X}}{\partial {y}_{0}^{′}} {\vert}_{{y}_{0} = 0}$$

The results are summarized in Table 10.1.

TABLE
Calculation of the camera position values r_{Zik}

| | r_{Z0k} | r_{Z1k} |
|---|---|---|
| rot_status | (derived from bunch₀) | (derived from bunch₁) |
| 0 | ${r}_{z 00} = \frac{b \cdot {c}_{grid} \cdot cos {φ}_{Y}}{{g}_{C 0} \cdot ( cos {φ}_{Z} - tan {φ}_{X} sin {φ}_{Y} sin {φ}_{Z} )}$ | ${r}_{z 10} = \frac{b \cdot {c}_{grid} \cdot cos {φ}_{X}}{{g}_{C 1} \cdot cos {φ}_{Z}}$ |
| 1 | ${r}_{z 01} = \frac{b \cdot {c}_{grid} \cdot cos {φ}_{Y}}{{g}_{C 0} \cdot ( - sin {φ}_{Z} - tan {φ}_{X} sin {φ}_{Y} cos {φ}_{Z} )}$ | ${r}_{z 11} = \frac{b \cdot {c}_{grid} \cdot cos {φ}_{X}}{{g}_{C 1} \cdot sin {φ}_{Z}}$ |

By introducing the angle

$$β = rot\_status \cdot \frac{π}{2} ,$$

the equations can be combined:

$${r}_{Z 0 k} = \frac{b \cdot {c}_{g r i d} \cdot cos {φ}_{Y}}{{g}_{C 0} \cdot ( cos ( {φ}_{Z} + β ) - tan {φ}_{X} sin {φ}_{Y} sin ( {φ}_{Z} + β ) )}$$

$${r}_{Z 1 k} = \frac{b \cdot {c}_{g r i d} \cdot cos {φ}_{X}}{{g}_{C 1} \cdot cos ( {φ}_{Z} - β )}$$

In order to output only one value r_{Z} per image, the average value of the two z values is calculated:

$${r}_{Z} = \frac{{r}_{Z 0 k} + {r}_{Z 1 k}}{2}$$

Substep 700—Calculation of the Camera Angles φ_{X}, φ_{Y}

$$\frac{\partial {α}_{k} ( i )}{{\partial }_{i}}$$

The angles φ_{X}, φ_{Y} are derived from the angular divergence of the two line bundles bunchₖ in the image center. In step 600, the slope m₁ for the line bundle bunch₁ was derived as a function of the line index y₀:

$${m}_{1} ( {y}_{0} ) = \frac{( sin {φ}_{X} sin {φ}_{Z} - cos {φ}_{X} sin {φ}_{Y} cos {φ}_{Z} ) \cdot {y}_{0} - cos {φ}_{Y} sin {φ}_{Z} \cdot {r}_{Z}}{( - sin {φ}_{X} cos {φ}_{Z} - cos {φ}_{X} sin {φ}_{Y} sin {φ}_{Z} ) \cdot {y}_{0} + cos {φ}_{Y} {cos}_{Z} \cdot {r}_{Z}}$$

The line angle α₁(y₀)=tan(m₁(y₀)) is calculated therefrom and differentiated with respect to

$${y}_{0}^{′} = \frac{{y}_{0}}{{c}_{g r i d}} [ dots ]$$

in order to obtain the angular divergence:

$$\frac{\partial {α}_{1} ( {y}_{0} )}{\partial {y}_{0}^{′}} = \frac{\partial {α}_{1} ( {y}_{0} )}{\partial {y}_{0}} \cdot {c}_{grid} = \frac{- {c}_{grid} \cdot cos {φ}_{X} sin {φ}_{Y} cos {φ}_{Y} \cdot {r}_{Z}}{{( {y}_{0} \cdot sin {φ}_{X} - {r}_{Z} \cdot cos {φ}_{Y} )}^{2} + {y}_{0}^{2} \cdot {cos}^{2} {φ}_{X} {sin}^{2} {φ}_{Y}}$$

In the image center y₀=0, the angular divergence is

$${\frac{\partial {α}_{1} ( {y}_{0} )}{\partial {y}_{0}^{′}} \vert}_{{y}_{0} = 0} = \frac{- {c}_{g r i d} \cdot cos {φ}_{X} tan {φ}_{Y}}{{r}_{Z}}$$

Equating to the measured angular divergence dα_{C1} results in the equation for φ_{Y}:

$$tan {φ}_{Y} = \frac{- d {α}_{C 1} \cdot {r}_{Z}}{{c}_{g r i d} \cdot cos {φ}_{X}}$$

In the same way, the angle φ_{X} results from the slope m₀ of a straight line in bunch₀. Analogously to the calculation in 600, the result is

$${m}_{0} ( {x}_{0} ) = \frac{\begin{matrix}( - sin {φ}_{X} sin {φ}_{Z} + cos {φ}_{X} sin {φ}_{Y} cos {φ}_{Z} ) \cdot {x}_{0} + \\ ( cos {φ}_{X} cos {φ}_{Z} - sin {φ}_{X} sin {φ}_{Y} sin {φ}_{Z} ) \cdot {r}_{Z}\end{matrix}}{\begin{matrix}( sin {φ}_{X} cos {φ}_{Z} + cos {φ}_{X} sin {φ}_{Y} sin {φ}_{Z} ) \cdot {x}_{0} + \\ ( cos {φ}_{X} sin {φ}_{Z} + sin {φ}_{X} sin {φ}_{Y} cos {φ}_{Z} ) \cdot {r}_{Z}\end{matrix}}$$

The angle α₀(x)=tan(m₀(x₀)) is differentiated with respect to

$${x}_{0}^{′} = \frac{{x}_{0}}{{c}_{grid}} ,$$

resulting in the angular divergence

$$\frac{\partial {α}_{0} ( {x}_{0} )}{\partial {x}_{0}^{′}} = \frac{\partial {α}_{0} ( {x}_{0} )}{\partial {x}_{0}} \cdot {c}_{g r i d} = \frac{- {c}_{g r i d} \cdot sin {φ}_{X} cos {φ}_{X} {cos}^{2} {φ}_{Y} \cdot {r}_{Z}}{{( {x}_{0} + {r}_{Z} \cdot cos {φ}_{X} )}^{2} - {x}_{0}^{2} \cdot {cos}^{2} {φ}_{X}}$$

In the image center x₀=0, the angular divergence is

$${\frac{\partial {α}_{0} ( {x}_{0} )}{\partial {x}_{0}^{′}} \vert}_{{x}_{0} = 0} = \frac{- {c}_{g r i d} \cdot {cos}^{2} {φ}_{Y} tan {φ}_{X}}{{r}_{Z}}$$

Equating to the measured angular divergence dα_{C0} results in the equation for φ_{X}:

$$tan {φ}_{X} = \frac{- d {α}_{C 0} \cdot {r}_{Z}}{{c}_{g r i d} \cdot {cos}^{2} {φ}_{Y}}$$

Substep 700—Iterative Calculation of the Camera Position Z and the Camera Angles φ_{X}, φ_{Y}

There are interdependencies between the functions φ_{X}, φ_{Y} and Z:

$${φ}_{X} = f ( {φ}_{y} , {r}_{Z} ) ; {φ}_{Y} = f ( {φ}_{X} , {r}_{Z} ) ; {r}_{Z} = f ( {φ}_{X} , {φ}_{y} )$$

The equations are therefore solved in an iterative process. With each iteration step, the accuracy of the camera position Z and of the camera angles φ_{X} and φ_{Y} increases. The algorithm is shown in the flowchart of FIG. 40.

Lower step 700.1: Calculation of the real fractions of the reading field position in [dots]

(r_{X,fract}, r_{Y,fract})

Lower step 700.2: Calculation of the position r_{X} and r_{Y}

Lower step 700.3: Calculation of the camera rotation/camera angle φ_{Z}

Lower step 700.4: Initialize the camera angles phix=0; phiy=0

Lower step 700.5: Initialize a counter for iterations with, e.g., 4

Lower step 700.6: Calculation of r_{Z0k} and r_{Z1k} and finally r_{Z}=(r_{Z0k}+r_{Z1k})/2

Lower step 700.7: Calculation of camera angles phix, phiy

Lower step 700.8: Counter=0? Recalculation, otherwise abort the iteration

Lower step 700.9: Error query

The algorithm converges quickly; the result is sufficiently stable after about 4 iterations. Finally, the following results are output:
Camera position (r_{X}, r_{Y}, r_{Z})
Camera angle (φ_{X}, φ_{Y}, φ_{Z})
Validity information

### LIST OF REFERENCE SIGNS

1 Camera
2 Code arrangement
3 Image
4 Point of intersection of the optical axis 5 with the code arrangement 2; point of incidence;
5 Optical axis
6 Empty
7 Point of intersection of the optical axis with the image sensor
8 Objects with at least one code arrangement 2
9 Objective
10 Focal point of the objective 9
11 Focal point of the objective 9
12 Image sensor
13 Optical center of the objective 9
14 View ray
15 Coordinate system (X_{I}, Y_{I}) of the image sensor 12 in the plane of the image sensor 12
16 Coordinate system (X_{C}, Y_{C}) of the code arrangement 2 in the plane of the code arrangement 2
17 Coordinate system (X, Y, Z) of the camera 1
18 Virtual image plane
19 Parcel
20 Base symbol
21 Parcel symbol
22 Reading field
23 Center position
24 X parcel regions
25 Y parcel regions
26 Partial region for additional data
27 Intersection point pattern
28 Starting field/starting basis/launch pad
29 Dot matrix
30 Start positions
31 Search rays
32 Center position of the reading field 22
33 Non-rectified dot raster
34 Rectified dot raster
35 Reading path in a first code direction
36 Reading path in a second code direction
37 First line bundle/bunch₀
38 Second line bundle/bunch₁

1-12. (canceled)

13. A method for ascertaining at least one degree of freedom of a camera relative to a code arrangement from a camera image of the camera, wherein the code arrangement includes a dot raster with a plurality of base symbols, wherein a coarse position of the base symbols is encoded in the code arrangement, wherein the base symbols define a first main direction and a second main direction, independent of the first main direction, along the dot raster, and wherein the camera image defines a coordinate system, the method comprising:
ascertaining a coarse position of a base symbol in a coordinate system of the code arrangement in a plane of the code arrangement from the camera image;
wherein a reference point is arranged in the camera image,
wherein a first axis intersection point function in the coordinate system of the camera image is formed by a first straight line, wherein the first straight line in the coordinate system of the code arrangement is aligned parallel to the first main direction of the dot raster, wherein the first axis intersection point function has a first function argument, wherein changing the first function argument shifts the first straight line parallel in the second main direction in the coordinate system of the code arrangement,
wherein the first axis intersection point function defines, as a function of the first function argument, a first axis intersection point along a first axis of the coordinate system of the camera image, wherein the first axis passes through the reference point,
wherein a second axis intersection point function in the coordinate system of the camera image is formed by a second straight line, wherein the second straight line in the coordinate system of the code arrangement is aligned parallel to the second main direction, wherein the second axis intersection point function has a second function argument, wherein changing the second function argument shifts the second straight line parallel in the first main direction in the coordinate system,
wherein the second axis intersection point function defines, as a function of the second function argument, a second axis intersection point along a second axis of the coordinate system of the camera image, wherein the second axis passes through the reference point;
determining, based on the first and second axis intersection point functions, the first and the second function argument such that the reference point forms the first and the second axis intersection point; and
determining, based on the first and the second function argument and the coarse position, a fine position of the reference point in the coordinate system of the code arrangement in the plane of the code arrangement, as the at least one degree of freedom.

14. The method according to claim 13, wherein: (i) the first function argument is configured as a count value of rows and/or (ii) the second function argument is configured as a count value of columns.

15. The method according to claim 13, wherein the reference point is a point of intersection of an optical axis of the camera with: (i) an image sensor and/or (ii) the camera image.

16. The method according to claim 13, wherein:
the first and second axis intersection point functions are linear functions for describing the first and second straight lines, respectively, or
a linear function is used, which is formed by a combination of a line angle function of a line angle with one axis of the coordinate system of the camera image as a function of the first or second function argument and the first or second axis intersection point function.

17. The method according to claim 13, wherein the fine position is determined based on the first and second function arguments and a known raster spacing of the dot raster.

18. The method according to claim 16, wherein a base symbol matrix is ascertained from the camera image, wherein a position of each of the base symbols in the camera image is entered in the base symbol matrix, wherein, based on the base symbol matrix: (i) a first linear function is derived as one of the linear functions with the first function argument in a coordinate system of the camera image for the first straight line, wherein the first straight line in the coordinate system of the code arrangement is aligned parallel to the first main direction, wherein changing the first function argument shifts the first straight line parallel in the second main direction in the coordinate system of the code arrangement, and/or (ii) a second linear function is derived as one of the linear functions with the second function argument in a coordinate system of the camera image for a second straight line, wherein the second straight line in the coordinate system of the code arrangement is aligned parallel to the second main direction, wherein changing the second function argument shifts the second straight line parallel in the first main direction in the coordinate system of the code arrangement.

19. The method according to claim 13, wherein the first and/or the second function argument is determined such that the first and/or the second straight line intersects the reference point, wherein an angle of rotation of the camera about the optical axis is derived as a degree of freedom of the camera relative to the code arrangement based on the first and/or the second straight line.

20. The method according to claim 13, wherein the reference point arranged in the camera image is a point of intersection of an optical axis of the camera with: (i) an image sensor and/or (ii) the camera image, wherein the following values at the reference point are determined as characteristic values from the camera image:
an angle of rotation of the camera about the optical axis of the camera,
a first local raster spacing of the dot raster in the camera image in the first main direction and/or a second local raster spacing of the dot raster in the camera image in the second main direction,
a first local angular divergence of the dot raster in the camera image in the first main direction, wherein the first local angular divergence describes a difference angle between two neighboring straight lines in the first main direction in the dot raster; and
a second local angular divergence of the dot raster in the camera image in the second main direction, wherein the second local angular divergence describes a difference angle between two neighboring straight lines in the second main direction in the dot raster;
wherein the following further three degrees of freedom of the camera relative to the code arrangement are determined based on the characteristic values:
a distance between the code arrangement and the camera;
two independent pitch angles of the optical axis to the code arrangement.

21. The method according to claim 18, wherein a starting field with base symbols is determined, wherein the starting field includes at least three base symbols, wherein two independent main directions along the dot raster in the camera image are estimated via the base symbols of the starting field, wherein the base symbols of the starting field form valid base symbols, wherein a search for further base symbols along at least one of the main directions is carried out in a searching step, starting from at least one valid base symbol, and wherein, based on a successful search, the further base symbols are marked as valid base symbols, wherein the searching step is performed multiple times, wherein the base symbol matrix is ascertained based on the valid base symbols or a subset of the value base symbols.

22. An electronic control unit or automation arrangement comprising the electronic control unit, wherein the control unit is configured to perform, using program technology and/or circuitry, a method for ascertaining at least one degree of freedom of a camera relative to a code arrangement from a camera image of the camera, wherein the code arrangement includes a dot raster with a plurality of base symbols, wherein a coarse position of the base symbols is encoded in the code arrangement, wherein the base symbols define a first main direction and a second main direction, independent of the first main direction, along the dot raster, and wherein the camera image defines a coordinate system, the method including:
ascertaining a coarse position of a base symbol in a coordinate system of the code arrangement in a plane of the code arrangement from the camera image;
wherein a reference point is arranged in the camera image,
wherein a first axis intersection point function in the coordinate system of the camera image is formed by a first straight line, wherein the first straight line in the coordinate system of the code arrangement is aligned parallel to the first main direction of the dot raster, wherein the first axis intersection point function has a first function argument, wherein changing the first function argument shifts the first straight line parallel in the second main direction in the coordinate system of the code arrangement,
wherein the first axis intersection point function defines, as a function of the first function argument, a first axis intersection point along a first axis of the coordinate system of the camera image, wherein the first axis passes through the reference point,
wherein a second axis intersection point function in the coordinate system of the camera image is formed by a second straight line, wherein the second straight line in the coordinate system of the code arrangement is aligned parallel to the second main direction, wherein the second axis intersection point function has a second function argument, wherein changing the second function argument shifts the second straight line parallel in the first main direction in the coordinate system,
wherein the second axis intersection point function defines, as a function of the second function argument, a second axis intersection point along a second axis of the coordinate system of the camera image, wherein the second axis passes through the reference point;
determining, based on the first and second axis intersection point functions, the first and the second function argument such that the reference point forms the first and the second axis intersection point; and
determining, based on the first and the second function argument and the coarse position, a fine position of the reference point in the coordinate system of the code arrangement in the plane of the code arrangement, as the at least one degree of freedom.

23. A non-transitory machine-readable storage medium on which is stored a computer program for ascertaining at least one degree of freedom of a camera relative to a code arrangement from a camera image of the camera, wherein the code arrangement includes a dot raster with a plurality of base symbols, wherein a coarse position of the base symbols is encoded in the code arrangement, wherein the base symbols define a first main direction and a second main direction, independent of the first main direction, along the dot raster, and wherein the camera image defines a coordinate system, the computer program, when executed by a computer, causing the computer to perform the following steps:
ascertaining a coarse position of a base symbol in a coordinate system of the code arrangement in a plane of the code arrangement from the camera image;
wherein a reference point is arranged in the camera image,
wherein a first axis intersection point function in the coordinate system of the camera image is formed by a first straight line, wherein the first straight line in the coordinate system of the code arrangement is aligned parallel to the first main direction of the dot raster, wherein the first axis intersection point function has a first function argument, wherein changing the first function argument shifts the first straight line parallel in the second main direction in the coordinate system of the code arrangement,
wherein the first axis intersection point function defines, as a function of the first function argument, a first axis intersection point along a first axis of the coordinate system of the camera image, wherein the first axis passes through the reference point,
wherein a second axis intersection point function in the coordinate system of the camera image is formed by a second straight line, wherein the second straight line in the coordinate system of the code arrangement is aligned parallel to the second main direction, wherein the second axis intersection point function has a second function argument, wherein changing the second function argument shifts the second straight line parallel in the first main direction in the coordinate system,
wherein the second axis intersection point function defines, as a function of the second function argument, a second axis intersection point along a second axis of the coordinate system of the camera image, wherein the second axis passes through the reference point;
determining, based on the first and second axis intersection point functions, the first and the second function argument such that the reference point forms the first and the second axis intersection point; and
determining, based on the first and the second function argument and the coarse position, a fine position of the reference point in the coordinate system of the code arrangement in the plane of the code arrangement, as the at least one degree of freedom
